(19) United States
(12) Patent Application Publication
(10) Pub. No.: US 2020/0239304 A1
(43) Pub. Date: Jul. 30, 2020

(54) LIGNIN COMPOSITIONS, METHODS OF PRODUCING THE COMPOSITIONS, METHODS OF USING LIGNIN COMPOSITIONS, AND PRODUCTS PRODUCED THEREBY

(71) Applicant: VIRDIA, INC., Raceland, LA (US)

(72) Inventors: Robert JANSEN, Collinsville, IL (US); Aharon EYAL, Jerusalem (IL); Noa LAPIDOT, Mevaseret Zion (IL); Bassem HALLAC, Jerusalem (IL); Ziv-Vladimir BELMAN, Yokneam Ilit (IL); Shmuel KENIG, Haifa (IL)

(21) Appl. No.: 16/564,169

(22) Filed: Sep. 9, 2019

Related U.S. Application Data
(63) Continuation of application No. 14/009,867, filed on May 13, 2014, now abandoned.
(60) Provisional application No. 61/473,134, filed on Apr. 7, 2011.
(60) Provisional application No. 61/483,663, filed on May 7, 2011.
(60) Provisional application No. 61/491,243, filed on May 30, 2011.
(60) Provisional application No. 61/626,307, filed on Sep. 22, 2011.
(60) Provisional application No. 61/552,402, filed on Oct. 27, 2011.
(60) Provisional application No. 61/559,529, filed on Nov. 14, 2011.
(60) Provisional application No. 61/602,514, filed on Feb. 23, 2012.
(60) Provisional application No. 61/620,186, filed on Apr. 4, 2012.
(60) Provisional application No. 61/620,195, filed on Apr. 4, 2012.

(30) Foreign Application Priority Data
Jun. 1, 2011 (IL) PCT/IL11/000424

(51) Int. Cl. C01B 3/02; C08K 13/02; C08J 3/20; C08L 23/12; C08H 7/00; C08L 97/00; C08L 55/02; D01F 9/00; D01F 9/17; C07G 1/00

(52) U.S. Cl. CPC C01B 3/02; C08K 13/02; C08J 3/20; C08L 23/12; C08H 6/00; C08L 97/005; Y10T 442/60; D01F 9/00; D01F 9/17; C07G 1/00; Y10T 442/30; C08J 2497/00; C08L 55/02

(57) ABSTRACT

Lignin compositions, products produced from them or containing them, methods to produce them, spinning methods, methods to convert lignin to a conversion product and conversion products produced by the methods are described.

### CROSS-REFERENCE

This application is a Continuation of U.S. application Ser. No. 14/009,867 filed May 13, 2014 and entitled “Lignin Compositions, Methods of Producing the Compositions, Methods of Using the Compositions, and Products Produced Thereby,” which is a National Stage Entry of International Application No. PCT/US2012/032227 filed Apr. 4, 2012 and entitled “Lignin Compositions, Methods of Producing the Compositions, Methods of Using the Compositions, and Products Produced Thereby.”

In accord with the provisions of 35 U.S.C. § 119(e) and § 363, International Application No. PCT/US2012/032227 claims the benefit of:

U.S. 61/473,134 filed on Apr. 7, 2011 by Aharon EYAL et al. and entitled “Lignocellulose Conversion Processes and Products”;

U.S. 61/483,663 filed on May 7, 2011 by Aharon EYAL et al. and entitled “Lignocellulose Conversion Processes and Products”;

U.S. 61/491,243 filed on May 30, 2011 by Aharon EYAL et al. and entitled “Methods and Systems for Processing Lignocellulosic Materials;”

U.S. 61/626,307 filed on Sep. 22, 2011 by Aharon EYAL et al. and entitled “Lignin and Lignin Particles”;

U.S. 61/552,402 filed on Oct. 27, 2011 by Aharon EYAL et al. and entitled “Lignin Compositions, Methods of Producing the Compositions, Methods of Using Lignin, and Products Produced Thereby”;

U.S. 61/559,529 filed on Nov. 14, 2011 by Aharon EYAL et al. and entitled “Lignin Compositions, Methods of Producing the Compositions, Methods of Using Lignin, and Products Produced Thereby”;

U.S. 61/602,514 filed on Feb. 23, 2012 by Aharon EYAL et al. and entitled “Lignin Compositions, Methods Of Producing The Compositions, Methods Of Using Lignin Compositions, and Products Produced Thereby”;

U.S. 61/620,186 filed on Apr. 4, 2012 by Aharon EYAL et al. and entitled “Lignin Compositions, Methods of Producing the Compositions, Methods Of Using Lignin Compositions, and Products Produced Thereby”; and

U.S. 61/620,195 filed on Apr. 4, 2012 by Aharon EYAL et al. and entitled “Lignin Compositions, Methods of Producing the Compositions, Methods Of Using Lignin Compositions, and Products Produced Thereby”; each of which is fully incorporated herein by reference.

In addition, in accord with the provisions of 35 U.S.C. § 119(a) and/or § 365 (b), International Application No. PCT/US2012/032227 claims priority from:

PCT/IL 2011/000424 filed on Jun. 1, 2011 by Robert JANSEN et al. and entitled “Lignin Compositions, Systems and Methods for Processing Lignin and/or HCl”; each of which is fully incorporated herein by reference.

### FIELD OF THE INVENTION

This invention relates to lignin, lignin particles, lignin compositions, methods to produce and/or use them and products produced therefrom.

### BACKGROUND OF THE INVENTION

Plant derived lignocellulosic materials or “woody materials” contain cellulose, hemicellulose and lignin as their main components. They may also contain mineral salts (ashes) and lipophilic organic compounds, such as tall oils. The type and content of these non-carbohydrate materials can vary depending upon the specific woody material.

Lignocellulosic materials typically contain 65-80% cellulose and hemicelluloses on a dry matter basis. Cellulose and hemicellulose are polysaccharides which can release carbohydrates suitable for fermentation and/or chemical conversion to products of interest if they are hydrolyzed. Lignin is typically resistant to acid hydrolysis.

Acid hydrolysis of a lignocellulosic substrate using strong acids (e.g. sulfuric acid or hydrochloric acid) forms a liquid hydrolyzate containing soluble carbohydrates, contaminants soluble in aqueous acid solution and the acid. Typically, the acid is diluted to some degree by release of water from the substrate.

Since lignin present in the substrate does not hydrolyze and stays essentially insoluble, the acid hydrolysis also produces lignin dispersed in, or wetted by, an aqueous solution of acid (e.g. HCl).

A primary industrial use of lignin is currently combustion as fuel. It is estimated that approximately 70 million tons of lignin are burned each year. Much of this material is presently available as Kraft black liquor from the paper industry.

Lignin is more energy rich than wood on a dry matter basis.

### SUMMARY OF THE INVENTION

A broad aspect of the invention relates to increasing the value of lignin. In some embodiments, the lignin is a byproduct of hydrolysis of lignocellulosic or woody materials. This hydrolysis may be, for example, with acids, reactive fluids or enzymes.

One aspect of some embodiments of the invention relates to lignin compositions which are liquid, have a relatively high concentration of lignin (e.g. at least 20, at least 30, at least 40, or at least 50% or even as much as 90% or more by weight) and a low mineral content. In some embodiments, a low sulfur and/or phosphorus content contributes to acceptability of the compositions as input materials for various conversion processes.

Another aspect of some embodiments of the invention relates to converting lignin to a conversion product. According to various exemplary embodiments of the invention this conversion relies upon one or more chemical reactions. In many cases the reactions are catalyzed and/or require an input of hydrogen.

Another aspect of some embodiments of the invention relates to producing hydrogen from lignin. In some embodiments, hydrogen produced from lignin is used to convert additional lignin into a conversion product.

Various exemplary embodiments of the invention relate to conversion products produced from the lignin compositions described above and/or using the methods described above, to consumer products produced from such conversion products and/or to consumer products containing the conversion products as an ingredient or component.

Another aspect of some embodiments of the invention relates to lignin compositions. According to various exemplary embodiments of the invention the compositions are provided as solids and/or gels and/or solutions and/or suspensions and/or a viscous paste. In some embodiments, a lignin composition provided as a solution is used to prepare a solid composition. Such solid compositions are additional exemplary embodiments of the invention. Optionally, solid lignin compositions are provided as fibers. In some exemplary embodiments of the invention, the lignin composition is incorporated into a product comprising additional ingredients.

Another aspect of some embodiments of the invention relates to solid lignin particles suspended in a solvent which also contains dissolved lignin as a solute.

Another aspect of some embodiments of the invention relates to positively charged particles suspended in a solvent which also contains dissolved lignin as a solute. Optionally, the particles contain metal oxides.

Another aspect of some embodiments of the invention relates to spinning of lignin to form fibers. According to various exemplary embodiments of the invention the spinning process includes wet spinning and/or melt spinning and/or gel spinning.

One aspect of some embodiments of the invention relates to the physical structure of lignin particles. In some exemplary embodiments of the invention, particles of lignin tend to retain a “woody” structure. Optionally, this woody structure is characterized by elongate flattish pieces and/or hollow tubes passing through the individual pieces.

One aspect of some embodiments of the invention relates to the ash content of the lignin. In some exemplary embodiments of the invention, the ash content is less than 1%, 0.9%, 0.8%, 0.7%, 0.6%, 0.5%, 0.4%, 0.3%, 0.38% on a dry matter basis. Alternatively or additionally, sulfur content is less than 0.5%. 0.1%, 0.07%, 0.05%, 0.03% on a dry matter basis. Optionally, ash components include one or more of aluminum, calcium, iron, potassium, magnesium, sodium, sulfur, silicon and zinc.

One aspect of some embodiments of the invention relates to the elemental ratio of lignin in the composition. In some exemplary embodiments of the invention, there are 9 to 12 hydrogen molecules and/or 1 to 5 oxygen molecules for every 9 carbon molecules in the lignin.

One aspect of some embodiments of the invention relates to a differential scanning calorimeter profile (DSC) of lignin in the composition. In some exemplary embodiments of the invention, the lignin is characterized by an endotherm between 130 and 250° C. Optionally, this endotherm may indicate a softening point of the lignin.

One aspect of some embodiments of the invention relates to lignin characterized by a low degree of solubility. For example, lignin according to some exemplary embodiments of the invention, may have a solubility of less than 5% in MF25 (2-(2-ethoxyethoxy) ethylacetate) and/or less than 15% in DMC (dimethylformamide) and/or less than 19% in DMSO (dimethylsulfoxide). In some exemplary embodiments of the invention, lignin exhibits a relatively low solubility in an alkaline media, such as 5% NaOH in water, at a temperature lower than 80° C.

It will be appreciated that some of the aspects described above relate to solution of technical problems associated with retaining the high energy value of lignin as it is converted into a more useful product.

Alternatively or additionally, it will be appreciated that some of the aspects described above relate to solution of technical problems related to improving yields in established conversion processes.

Alternatively or additionally, it will be appreciated that some of the aspects described above relate to solution of technical problems associated with lignin purification (e.g. separation of lignin from residual contaminants such as HCl and/or ash and/or soluble carbohydrates).

Alternatively or additionally, it will be appreciated that some of the aspects described above relate to solution of technical problems associated with use of lignin as an input material for downstream industrial processes (e.g. production of fiber based materials using lignin as a starting material).

In some exemplary embodiments of the invention, there is provided a composition including: a liquid including at least 20% lignin by weight and characterized by a sulfur concentration of less than 0.07% by weight. In some embodiments, the liquid includes at least 90% lignin. Alternatively or additionally, in some embodiments the composition includes less than 1% by weight soluble sugars. Alternatively or additionally, in some embodiments the composition includes phosphorus at a concentration of less than 100 PPM. Alternatively or additionally, in some embodiments the lignin is characterized by an O/C ratio less than 0.34. Alternatively or additionally, in some embodiments the lignin is characterized by an H/C ratio less than 2. Alternatively or additionally, in some embodiments the solution has a pH ≥9.0. In some embodiments, the composition includes an organic solvent. Alternatively or additionally, in some embodiments the organic solvent is selected from the group consisting of an alcohol, a ketone, an aldehyde, an alkane, an organic acid and a furan of 6 carbons or less. Alternatively or additionally, in some embodiments the composition includes a product of an aqueous-phase reforming reaction (APR). In some embodiments, the product of an APR is the result of APR conducted on a substrate including at least one member of the group consisting of a carbohydrate, lignin and a lignin decomposition product (LDP). In some embodiments, the product of an APR is the result of APR conducted on a substrate which does not include carbohydrates. Alternatively or additionally, in some embodiments, the composition includes at least one LDP selected from the group consisting of a pyrolytic oil, a phenol, an aldehyde and an aliphatic compound. Alternatively or additionally, in some embodiments at least 10% of the lignin has a molecular weight of less than 10 kDa (kiloDaltons). Alternatively or additionally, in some embodiments at least 10% of the lignin has a molecular weight in the range between 0.2 KDa and 5 kDa. Alternatively or additionally, in some embodiments the composition includes at least 10 ppm of an S1 solvent. Alternatively or additionally, in some embodiments the composition includes at least 10 ppm of at least one marker molecule. Alternatively or additionally, in some embodiments the composition includes at least 1% cellulose. Alternatively or additionally, in some embodiments the composition includes one or more furfurals at a total concentration of at least 10 PPM. Alternatively or additionally, in some embodiments the composition includes ash at a concentration of less than 0.5%. Alternatively or additionally, in some embodiments the composition includes tall oils at a total concentration of less than 0.5%. Alternatively or additionally, in some embodiments the composition includes chloride at a total concentration of at least 100 ppm.

In some exemplary embodiments of the invention, there is provided a method including: (a) providing a composition according to any one of claims 1 to 21, and (b) converting at least a portion of lignin in the composition to a conversion product. In some embodiments, the converting includes treating with hydrogen. Alternatively or additionally, in some embodiments the method includes producing hydrogen from lignin. Alternatively or additionally, in some embodiments the conversion product includes at least one item selected from the group consisting of bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, phenols, toluenes, and xylenes. Alternatively or additionally, in some embodiments the conversion product includes a fuel or a fuel ingredient. Alternatively or additionally, in some embodiments the conversion product includes para-xylene. Alternatively or additionally, in some embodiments the converting includes aqueous phase reforming (APR). Alternatively or additionally, in some embodiments the converting includes at least one reaction type selected from the group consisting of catalytic hydrotreating and catalytic condensation. Alternatively or additionally, in some embodiments the converting includes at least one reaction type selected from the group consisting of zeolite (e.g. ZSM-5) acid condensation, base catalyzed condensation, hydrogenation, dehydration, alkene oligomerization and alkylation (alkene saturation). Alternatively or additionally, in some embodiments the converting occurs in at least two stages. Alternatively or additionally, in some embodiments a first stage includes aqueous phase reforming. Alternatively or additionally, in some embodiments a second stage includes at least one of catalytic hydrotreating and catalytic condensation. Alternatively or additionally, in some embodiments the method is characterized by a hydrogen consumption of less than 0.07 ton per ton of product.

In some exemplary embodiments of the invention, there is provide a method comprising: (a) producing hydrogen from lignin in a first reaction; (b) treating additional lignin to form an intermediate product; and (c) converting the intermediate product to a conversion product; wherein at least one of the treating and converting includes contacting with at least a portion of the hydrogen. In some embodiments, the treating includes reducing an amount of ash in the intermediate product. Alternatively or additionally, in some embodiments the first reaction includes at least one reaction type selected from the group consisting of aqueous phase reforming (APR), pyrolysis and gasification. Alternatively or additionally, in some embodiments the intermediate product includes a liquid comprising at least 20% lignin by weight and characterized by a sulfur concentration of less than 0.07% by weight. Alternatively or additionally, in some embodiments the treating includes at least one reaction type selected from the group consisting of hydrogenolysis, hydrogenation, pyrolysis, dissolution in an organic solvent and dissolution in an alkaline solution. Alternatively or additionally, in some embodiments the converting occurs in at least two stages. Alternatively or additionally, in some embodiments a first stage includes aqueous phase reforming. Alternatively or additionally, in some embodiments a second or subsequent stage includes at least one of catalytic hydrotreating and catalytic condensation. Alternatively or additionally, in some embodiments the converting includes aqueous phase reforming (APR). Alternatively or additionally, in some embodiments the converting includes at least one reaction type selected from the group consisting of zeolite (e.g. ZSM-5) acid condensation, base catalyzed condensation, hydrogenation, dehydration, alkene oligomerization and alkylation (alkene saturation). Alternatively or additionally, in some embodiments the method includes consuming an additional portion of the hydrogen during the converting. Alternatively or additionally, in some embodiments the method is characterized by a hydrogen consumption of less than 0.07 ton per ton of product. Alternatively or additionally, in some embodiments the converting yields a product characterized by an O/C ratio <1 with carbon yield of at least 70%. Alternatively or additionally, in some embodiments the converting yields a product characterized by an O/C ratio <1 with weight yield of at least 50%.

In some exemplary embodiments of the invention, there is provided a conversion product produced according to a method as described herein, a consumer product produced from the conversion product or a consumer product containing the conversion product as an ingredient or component. In some exemplary embodiments of the invention, the product is characterized by a sulfur concentration of less than 0.07% by weight. Alternatively or additionally, in some exemplary embodiments of the invention, the product is characterized by soluble sugar content of less than 1 by weight. Alternatively or additionally, in some embodiments the product is characterized by a phosphorus concentration of less than 100 PPM. Alternatively or additionally, in some embodiments the product is characterized by total ash at a concentration of less than 0.5% wt. Alternatively or additionally, in some embodiments the product is characterized by tall oils at a total concentration of less than 0.5%. Alternatively or additionally, in some embodiments the product includes at least one chemical selected from the group consisting of lignosulfonates, bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene and pharmaceuticals. Alternatively or additionally, in some embodiments, the product includes para-xylene. Alternatively or additionally, in some embodiments the product is selected from the group consisting of dispersants, emulsifiers, complexants, flocculants, agglomerants, pelletizing additives, resins, carbon fibers, active carbon, antioxidants, liquid fuel, aromatic chemicals, vanillin, adhesives, binders, absorbents, toxin binders, foams, coatings, films, rubbers and elastomers, sequestrants, fuels, and expanders. Alternatively or additionally, in some embodiments the product is used in an area selected from the group consisting of food, feed, materials, agriculture, transportation and construction. Alternatively or additionally, in some embodiments the product has a ratio of carbon-14 to carbon-12 of about 2.0×10⁻¹³ or greater. Alternatively or additionally, in some embodiments the product includes an ingredient as described above and an ingredient produced from a raw material other than lignocellulosic material. Alternatively or additionally, in some embodiments the ingredient as described above and the ingredient produced from a raw material other than lignocellulosic material are essentially of the same chemical composition. Alternatively or additionally, in some embodiments the product includes a marker molecule at a concentration of at least 100 ppb. Alternatively or additionally, in some embodiments, the marker molecule is selected from the group consisting of furfural and hydroxy-methyl furfural, products of their condensation, color compounds, acetic acid, methanol, galcturonic acid, glycerol, fatty acids and resin acids.

In some exemplary embodiments of the invention, there is provided a method including: (a) hydrolyzing a lignocellulosic substrate to produce polymeric solid lignin; and (b) liquefying the solid lignin to form a liquid comprising at least 20% lignin by weight and characterized by a sulfur concentration of less than 0.07% by weight. In some embodiments, the liquefying includes de-polymerizing the polymeric lignin. Alternatively or additionally, in some embodiments the liquefying includes at least one action selected from the group consisting of contacting the lignin with an alkaline solution, contacting the lignin with an organic solvent, pyrolysis, gasification, hydrogenolysis, oxidation, reduction, base-catalyzed depolymerization and hydrolysis. Alternatively or additionally, in some embodiments the liquefying includes hydrogenolysis. Alternatively or additionally, in some embodiments the polymeric solid lignin is produced as an acidic stream and comprising: contacting the stream with an S1 solvent to produce solvent containing lignin; dissolving the solvent containing lignin in a basic solution (pH≥9); and separating the solvent from the basic solution. Alternatively or additionally, in some embodiments the liquefying includes contacting the solid lignin with both a basic solution and a solvent. Alternatively or additionally, in some embodiments the liquefying includes contacting with a basic solution (pH≥9) at a temperature ≥120° C. Optionally, ammonia or an ammonium salt is used to achieve pH≥9. Optionally, the liquefying includes contacting with an organic solvent. Optionally, the organic solvent includes at least one member of the group consisting of mono-, di- or tri-oxygenates comprising 2-6 carbons. Alternatively or additionally, in some embodiments the organic solvent is a product of an aqueous phase reforming reaction (APR). Alternatively or additionally, in some embodiments the method includes performing APR on the liquid. Alternatively or additionally, in some embodiments the liquefying includes removal of at least a portion of the ash.

In some exemplary embodiments of the invention, there is provided a lignin composition characterized (on a dry matter basis) by at least one characteristic selected from the group consisting of: (a) a formula of C₉H_{X}O_{Y}; wherein X is at least 9 and Y is less than 5; (b) a chloride (Cl) content of at least 0.05%; (c) a chloride (Cl) content of less than 1%; (d) a covalently bound chlorine (Cl) content of at least 10 PPM; (e) an O/C ratio less than 0.34; (f) an O/C ratio less than previously reported for lignin from a same specific lignocellulosic source; (g) an H/C ratio less than 2; (h) a solubility of less than 30% in DMSO (dimethylsulfoxide) at room temperature after high shear mixing; (i) a solubility of less than 20% in DMF (dimethylformamide) at room temperature after high shear mixing; (j) an ash content of less than 0.5%; (k) a sulfur content of less than 0.07%; (1) a phosphorus content of less than 100 PPM; (m) a soluble carbohydrate content of less than 5%; (n) a marker molecule content of at least 10 PPM; (o) a furfurals content of at least 10 PPM; (p) a detectable amount (e.g. at least 100 PPB) of hydroxymethyl furfural; (q) furfurals including oligomers of 3 to 10 furfural units; (r) a lignin decomposition products (LDP) content of less than 1000 PPM; (s) an LDP content including at least 100 PPB of at least one member of the group consisting of a pyrolytic oil, a phenol, an aldehyde and an aliphatic compound; (t) a residual S1 solvent content of at least 10 PPM; (u) presence of a lignin polymer bound to an alcohol of at least 6 carbons by an ether bond; (v) a tall oil content of less than 0.5%; (w) a dry basis content of carboxylic functions greater than 0.05%; and (x) at least 75% of lignin in the composition having molecular weight greater than 50 kDa; (y) a solubility of less than 10% in 2-(2-ethoxyethoxy) ethylacetate at room temperature after high shear mixing;

(z) no detectable release of phenolics after incubation at 121° C. for 1 h in 3% H₂SO₄;
(aa) no detectable release of phenolics after incubation at 121° C. for 3 h in 48% HBr;
(ab) a solubility of less than 20% in 5% NaOH in water after incubation for 3 hours at 75° C.; (ac) less than 0.1, less than 0.05, less than 0.01 or even less than 0.001 times the amount of volatile sulfur compounds found in Kraft lignin; (ad) an energy value of at least 5950, optionally at least 6000 cal/gram as measured by ASTM D240 calorimetry; and (ae) total non lignin components ≤5%, optionally ≤3%. In some embodiments, the composition is characterized by at least two of the characteristics from the group. In some embodiments, the composition is characterized by at least three of the characteristics from the group. In some embodiments, the composition is characterized by at least at least four, of the characteristics from the group. In some embodiments, the composition is characterized by at least five, six, seven or an even larger number of the characteristics from the group. Alternatively or additionally, in some embodiments the composition is provided as a solid. Alternatively or additionally, in some embodiments the composition is provided as fibers. Alternatively or additionally, in some embodiments the composition is provided as a solution in a main solvent. Alternatively or additionally, in some embodiments the composition is provided as a suspension in a main solvent. Alternatively or additionally, in some embodiments the main solvent includes at least one of water and a water-soluble solvent. Alternatively or additionally, in some embodiments there is provided a product including a lignin composition as described herein and one or more other ingredients. According to various exemplary embodiments of the invention the product is selected from the group consisting of: carbon fibers, protective coatings, lignosulfonates, bio-oils, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene, pharmaceuticals, dispersants, emulsifiers, complexants, flocculants, agglomerants, pelletizing additives, resins, active carbon, antioxidants, liquid fuels, aromatic chemicals, vanillin, adhesives, binders, absorbents, toxin binders, foams, films, rubbers, elastomers, sequestrants, solid fuels, expanders a liquid fuels, paints, dyes, glues, plastics, wet spun fibers, melt spun fibers and flame retardants. Alternatively or additionally, in some exemplary embodiments of the invention, there is provided a viscous paste including a lignin composition as described herein.

In some exemplary embodiments of the invention, there is provided a lignin formulation including: (a) finely milled solid lignin; and (b) lignin in solution at a controlled concentration. In some exemplary embodiments of the invention, there is provided a lignin formulation including: (a) lignin in solution at a controlled concentration and (b) positively charged particles suspended in the solution. In some embodiments, the positively charged particles include metal oxides. In some embodiments, the metal oxides include at least one of TiO₂ and Al₂O₃.

In some exemplary embodiments of the invention, there is provided a method for the production of a lignin composition according as described herein including: (a) generating a solid composition including lignin and less than 5% hemicellulose sugars; and (b) solubilizing lignin in the composition to form a lignin solution. In some embodiments, the generating includes: providing a lignocellulosic substrate; and removing at least a portion of ash, tall oils and hemicellulose sugars from the substrate. Alternatively or additionally, in some embodiments the solid composition includes cellulose and the solubilizing lignin leaves solid cellulose. Alternatively or additionally, in some embodiments the solid composition includes cellulose and the method includes: hydrolyzing cellulose using a mineral acid solution to form a sugar solution and solid lignin; and de-acidifying the solid lignin.

In some exemplary embodiments of the invention, there is provided a spinning method including, (a) providing a composition as described herein; (b) contacting the composition with an anti-solvent so that the lignin begins to solidify; (c) spinning the lignin to produce fibers. In some embodiments, the method includes removing the antisolvent from the fibers.

In some exemplary embodiments of the invention, there is provided a spinning method including: (a) providing a composition as described above; (b) melting lignin in the composition; and (c) spinning and cooling the lignin to produce fibers. In some embodiments, the melting is conducted in the presence of plasticizers.

In some exemplary embodiments of the invention, there is provided a spinning method including: (a) providing a composition as described above; (b) spinning the lignin to produce fibers; and (c) drying the fibers as they are formed.

In some embodiments, one or more of the spinning methods described above includes carbonizing the fibers to produce carbon fibers. In some exemplary embodiments of the invention, a lignin fiber and/or carbon fiber produced by a method as described above is used to produce a product. Alternatively or additionally, some embodiments of the invention relate to products (or components of products) including and/or produced from a fiber as described above (e.g. fabrics, sports equipment, automobiles, airplanes, boats, musical instruments and loudspeakers). Alternatively or additionally, some embodiments of the invention relate to an insulation material including a fiber as described above. Alternatively or additionally, some embodiments of the invention relate to a composite material including a polymer including one or more materials selected from the group consisting of epoxy, polyester, vinyl ester and nylon reinforced with fibers as described above.

In some exemplary embodiments of the invention, there is provided lignin characterized by a formula of C₉H_{X}O_{Y}; wherein X is at least 9 and Y is less than 5.

Optionally, Y is less than 3, optionally less than 2.5, optionally less than 2.

In some exemplary embodiments of the invention, there is provided lignin characterized by a chloride (Cl) content of at least 0.05%, optionally at least 0.1%, optionally at least 0.2%.

In some exemplary embodiments of the invention, there is provided lignin characterized by a chloride (Cl) content of less than 1%, optionally less than 0.8%, optionally less than 0.5%.

In some exemplary embodiments of the invention, there is provided lignin characterized by a covalently bound chlorine (Cl) content of at least 10 PPB, optionally at least 100 PPB, optionally at least 10 PPM, optionally 25 PPM, optionally 50 PPM, optionally 100 PPM.

In some exemplary embodiments of the invention, there is provided lignin characterized by an O/C ratio less than 0.34, optionally less than 0.3, optionally less than 0.25.

In some exemplary embodiments of the invention, there is provided lignin from a specific lignocellulosic source characterized by an O/C ratio less than previously reported for lignin from the same specific lignocellulosic source.

In some exemplary embodiments of the invention, there is provided lignin characterized by a solubility of less than 30% in DMSO (dimethylsulfoxide) at room temperature after high shear mixing. Optionally, the solubility in DMSO is less than 20%.

Optionally, the lignin is characterized by a solubility of less than 20% in DMF (dimethylformamide) at room temperature after high shear mixing. Optionally, the solubility in DMF is less than 15%.

Optionally, the lignin is characterized by a solubility of less than 10% in 2-(2-ethoxyethoxy) ethylacetate at room temperature after high shear mixing. Optionally, the solubility in 2-(2-ethoxyethoxy) ethylacetate is less than 5%.

In some exemplary embodiments of the invention, there is provided lignin characterized by no detectable release of phenolics after incubation at 121° C. for 1 hour in 3% H₂SO₄.

In some exemplary embodiments of the invention, there is provided lignin characterized by less than 0.1% conversion into phenolics after incubation at 121° C. for 1 h in 3% H₂SO₄.

In some exemplary embodiments of the invention, there is provided lignin characterized by a solubility of less than 30% in DMSO (dimethylsulfoxide) at room temperature after high shear mixing after the incubation.

In some exemplary embodiments of the invention, there is provided lignin characterized by no detectable release of phenolics after incubation at 121° C. for 3 hours in 48% HBr.

In some exemplary embodiments of the invention, there is provided lignin characterized by less than 0.1% conversion into phenolics after incubation at 121° C. for 3 h in 48% HBr.

Optionally, the lignin is characterized by a solubility of less than 30% in DMSO (dimethylsulfoxide) at room temperature after high shear mixing after the incubation.

Optionally, the lignin is characterized by a solubility of less than 20, optionally less than 15, optionally less than 10% in 5% NaOH in water after incubation for 3 hours at 75° C.

In some exemplary embodiments of the invention, there is provided lignin characterized by an ash content of less than 0.5%, optionally less than 0.4%, optionally less than 0.3%, optionally less than 0.2%, optionally less than 0.1%.

In some exemplary embodiments of the invention, there is provided lignin characterized by a sulfur content of less than 0.07%, optionally less than 0.05%, optionally less than 0.03%.

Alternatively or additionally, in some exemplary embodiments of the invention there is provided lignin characterized by a sulfur content of less than 100 PPM, optionally less than 70 PPM, optionally less than 50 PPM.

In some exemplary embodiments of the invention, there is provided lignin characterized by a phosphorus content of less than 100 PPM, optionally less than 50 PPM, optionally less than 25 PPM, optionally less than 10 PPM, optionally less than 1 PPM, optionally less than 0.1 PPM, optionally less than 0.01 PPM.

In some exemplary embodiments of the invention, there is provided lignin characterized by a soluble carbohydrate content of less than 5%, optionally 3%, optionally 2%, optionally 1%.

In some exemplary embodiments of the invention, there is provided lignin including one or more furfurals at a total concentration of at least 10 PPM, optionally at least 25 PPM, optionally at least 50 PPM, optionally at least 100 PPM. Optionally, the furfurals include hydroxymethyl furfural. Optionally, the furfurals include oligomers of 3 to 10 furfural units.

In some exemplary embodiments of the invention, there is provided lignin including at least at least 10, optionally at least 20, optionally at least 50, optionally at least 100 PPM of S1 solvent. Optionally, the S1 solvent includes hexanol and/or 2-ethyl-1-hexanol.

In some exemplary embodiments of the invention, there is provided a lignin particle characterized by lengthwise tubules with a transverse cross-sectional dimension of at least 5 microns. Optionally, the transverse cross-sectional dimension is less than 20 microns. Optionally, the tubules are characterized by an aspect ratio of transverse cross-sectional dimension to length less than 0.1. Optionally, the aspect ratio is less than 0.025.

In some exemplary embodiments of the invention, there is provided a population of lignin particles, wherein at least 0.1% of particles in the population are particles as described above.

In some exemplary embodiments of the invention, there is provided a composition including lignin and cellulose and having an elemental formula of C₉H_{11.78}O_{4.24}.

In some exemplary embodiments of the invention, there is provided a composition including lignin and cellulose and having an elemental formula of C₉H_{11.25}O_{3.68}.

In some exemplary embodiments of the invention, there is provided a composition including lignin and cellulose and having an elemental formula of C₉H_{10.72}O_{3.11}.

In some exemplary embodiments of the invention, there is provided a composition including lignin and cellulose and having an elemental formula of C₉H_{10.18}O_{2.55}.

In some exemplary embodiments of the invention, there is provided a molecule including a lignin polymer bound to an alcohol of at least 6 carbons by an ether bond.

In some exemplary embodiments of the invention, there is provided a method including: providing an input material including lignin as described above and/or lignin particles as described above and/or a composition as described above and/or molecules as described above; and processing the input material to produce a processed product. Optionally, the processed product includes one or more members selected from the group consisting of carbon fibers, activated carbon, activated carbon fibers, absorbent materials, coatings, phenol resins, adhesives, dispersants, flocculants, phenols, terphthalate, epoxies, BTX (Benzene/Toluene/Xylene), liquid fuels, polyols and polyolefins.

In some exemplary embodiments of the invention, there is provided a processed product produced by a method as described above.

In some exemplary embodiments of the invention, there is provided a method including: providing a processed product as described above; and subjecting the processed product to an industrial process to produce a downstream product.

Optionally, the downstream product is selected from the group consisting of a hygienic pad, a diaper and a wound dressing, sports equipment, a structural component, a paint and a dye.

In some exemplary embodiments of the invention, there is provided a downstream product produced by a method as described above.

In some exemplary embodiments of the invention, there is provided a method including providing a processed product as described above; and using the processed product as an ingredient or component in a downstream product. Optionally, the downstream product is selected from the group consisting of a liquid fuel, a paint, a dye, a glue and a plastic. In some exemplary embodiments of the invention, there is provided a downstream product produced by a method as described above.

In some exemplary embodiments of the invention, there is provided a lignin composition characterized (on a dry matter basis) by at least one characteristic selected from the group consisting of: (a) a formula of C₉H_{X}O_{Y}; wherein X is at least 9 and Y is less than 5; (b) a chloride (Cl) content of at least 50 PPM; (c) a chloride (Cl) content of less than 1% (d) a covalently bound chlorine (Cl) content of at least 10 PPB (e) an O/C ratio of less than 0.34; (f) an O/C ratio less than previously reported for lignin from a same specific lignocellulosic source; (g) an H/C ratio of less than 2; (h) an ash content of less than 0.5%; (i) a sulfur content of less than 70 PPM; (j) a phosphorus content of less than 100 PPM; (k) a soluble carbohydrate content of less than 5%; (1) a marker molecule content of at least 10 PPM; (m) a furfurals content of at least 10 PPM; (n) hydroxymethyl furfural content of at least 100 PPB; (o) containing furfurals including oligomers of 3 to 10 furfural units; (p) a lignin decomposition products (LDP) content of less than 1000 PPM; (q) an LDP content of at least 100 PPB, wherein the LDP includes at least one member of the group consisting of pyrolytic oils, phenols, aldehydes and aliphatic compounds; (r) a residual S1 solvent content of at least 1 PPM; (s) at least 10 PPB of a lignin polymer bound to an alcohol of at least 6 carbon atoms by an ether bond; (t) a tall oil content of less than 0.5%; (u) at least 75% of the lignin having molecular weight greater than 50 kDa; (v) less than 0.1% conversion into phenolics after incubation at 121° C. for 1 h in 3% H₂SO₄; (w) less than 0.1% conversion into phenolics after incubation at 121° C. for 3 h in 48% HBr; (x) less than 0.1 times the amount of volatile sulfur compounds found in Kraft lignin; (y) an energy value of at least 6000 cal/gram as measured by ASTM D240 calorimetry; and (z) total non lignin components ≤5%; wherein the composition is provided as a solution in a main solvent. In some embodiments, the composition includes at least 0.05% carboxylic functions on a dry basis. Alternatively or additionally, in some embodiments the composition includes: (i) includes less than 3% non-lignin material; (ii) an ash content of less than 0.1%; (iii) a total carbohydrate content of less than 0.05%; and (iv) a volatiles content of less than 5% at 200° C. Alternatively or additionally, in some embodiments the composition is characterized by at least two of the characteristics from the group (a to z). Alternatively or additionally, in some embodiments the composition is characterized by at least three of the characteristics from the group. Alternatively or additionally, in some embodiments the composition is characterized by at least four of the characteristics from the group. Alternatively or additionally, in some embodiments the composition is characterized by at least five of the characteristics from the group. Alternatively or additionally, in some embodiments the composition is prepared from a substrate which includes hardwood. Alternatively or additionally, in some embodiments the composition s prepared from a substrate which includes softwood. Alternatively or additionally, in some embodiments the composition is prepared from a substrate which includes hardwood and softwood. In some exemplary embodiments of the invention, there is provided a solid composition produced from a composition as described above. In some embodiments, the solid composition includes a non melting particulate content (>1 micron diameter; at 150° C.) of less than 0.05. Alternatively or additionally, in some embodiments the solid composition is provided as fibers. Alternatively or additionally, in some embodiments the main solvent includes at least one of water and a water-soluble solvent. In some embodiments, the solid is provided as a suspension in a suspension solvent. According to various exemplary embodiments of the invention the suspension solvent includes at least one of water and a water-soluble solvent. In some exemplary embodiments of the invention, there is provided a product including a lignin composition as described herein and one or more other ingredients. According to various exemplary embodiments of the invention the product is selected from the group consisting of: carbon fibers, protective coatings, lignosulfonates, pharmaceuticals, dispersants, emulsifiers, complexants, flocculants, agglomerants, pelletizing additives, resins, adhesives, binders, absorbents, toxin binders, films, rubbers, elastomers, sequestrants, solid fuels, paints, dyes, plastics, wet spun fibers, melt spun fibers and flame retardants. In some exemplary embodiments of the invention, there is provided a viscous paste, the paste includings a lignin composition as described herein. In some exemplary embodiments of the invention, there is provided a method for the production of a lignin composition as described herein, the method including: (a) generating a solid composition including lignin and less than 5% hemicellulose sugars; and (b) solubilizing lignin in the composition to form a lignin solution. In some embodiments, the generating includes: providing a lignocellulosic substrate; and removing at least a portion of ash, tall oils and hemicellulose sugars from the substrate. Alternatively or additionally, in some embodiments the solid composition includes cellulose and the solubilizing lignin leaves solid cellulose. Alternatively or additionally, in some embodiments the solid composition includes cellulose and the method includes hydrolyzing cellulose using a mineral acid solution to form a sugar solution and solid lignin; and de-acidifying the solid lignin. In some exemplary embodiments of the invention, there is provided a spinning method including: (a) providing a composition as described herein; (b) spinning the lignin to produce fibers; and (c) de-solventizing the fibers. In some embodiments, the method includes contacting the composition with an anti-solvent. Alternatively or additionally, in some embodiments the method includes mixing the composition with a synthetic polymeric material. Alternatively or additionally, in some embodiments the synthetic polymeric material includes polyacrylonitrile. Alternatively or additionally, in some embodiments a ratio of lignin:synthetic polymer is ≥1:10. Alternatively or additionally, in some embodiments a ratio of lignin:synthetic polymer is ≤10:1. Alternatively or additionally, in some embodiments the method includes carbonizing the fibers to produce carbon fibers. In some exemplary embodiments of the invention, there is provided a fiber produced by a method as described herein. In some exemplary embodiments of the invention, there is provided a product including a fiber as described herein. According to various exemplary embodiments of the invention the product is selected from the group consisting of: a non woven fabric, a woven fabric, insulation material, sports equipment, automotive parts, airplane or helicopter parts, boat hulls or portions thereof and loudspeakers. In some exemplary embodiments of the invention, there is provided a composite material including a polymer including one or more materials selected from the group consisting of epoxy, polyester, vinyl ester and nylon, the polymer reinforced with fibers according as described herein. In some exemplary embodiments of the invention, there is provided a method including: (a) providing a composition includes solid lignin; and (b) heating the composition in a basic solution at a temperature ≥150° C. to produce a lignin as described herein. In some embodiments, the method includes reducing a pH of the solution to ≤4.0 to re-solidify at least a portion of the lignin. Alternatively or additionally, in some embodiments the method includes extracting the solution with an organic solvent. Alternatively or additionally, in some embodiments the method includes performing at least one action selected from the group consisting of ultrafiltration and dialysis of the basic solution after the heating. Alternatively or additionally, in some embodiments the method includes separating the lignin from the organic solvent. Alternatively or additionally, in some embodiments the separating includes wet spinning the lignin from the solvent. Alternatively or additionally, in some embodiments the basic solution includes at least one of NaOH and ammonia. Alternatively or additionally, in some embodiments the basic solution includes at least one of anthraquinone and peroxide. In some embodiments, a composition as described herein includes: at least 20% lignin by weight and has a sulfur concentration of less than 0.07% by weight. Alternatively or additionally, in some embodiments the composition includes less than 0.1 times the amount of volatile sulfur compounds found in Kraft lignin. Alternatively or additionally, in some embodiments the solution includes at least 90% lignin. Alternatively or additionally, in some embodiments the composition includes less than 1% by weight soluble sugars. Alternatively or additionally, in some embodiments the composition includes phosphorus at a concentration of less than 100 PPM. Alternatively or additionally, in some embodiments the lignin has an O/C ratio less than 0.34. Alternatively or additionally, in some embodiments the lignin has an H/C ratio less than 2. Alternatively or additionally, in some embodiments the solution has a pH ≥9.0. Alternatively or additionally, in some embodiments the organic solvent is selected from the group consisting of an alcohol of 6 carbons or less, a ketone of 6 carbons or less, an aldehyde of 6 carbons or less, an alkane of 6 carbons or less, an organic acid of 6 carbons or less and a furan of 6 carbons or less. Alternatively or additionally, in some embodiments the composition includes a product of an aqueous-phase reforming reaction (APR). In some embodiments the product of an APR is the result of APR conducted on a substrate including at least one member of the group consisting of a carbohydrate, lignin and a lignin decomposition product (LDP). Alternatively or additionally, in some embodiments the product of an APR is the result of APR conducted on a substrate includes less than 5% carbohydrates. Alternatively or additionally, in some embodiments the composition includes at least one LDP selected from the group consisting of a pyrolytic oil, a phenol, an aldehyde and an aliphatic compound. Alternatively or additionally, in some embodiments at least 10% of the lignin has a molecular weight of less than 10 kDa. Alternatively or additionally, in some embodiments at least 10% of the lignin has a molecular weight in the range between 0.2 kDa and 5 kDa. Alternatively or additionally, in some embodiments the composition includes at least 10 ppm of an S1 solvent. Alternatively or additionally, in some embodiments the composition includes at least 10 ppm of at least one marker molecule. Alternatively or additionally, in some embodiments the composition includes at least 1% cellulose. Alternatively or additionally, in some embodiments the composition includes one or more furfurals at a total concentration of at least 10 PPM. Alternatively or additionally, in some embodiments the composition includes ash at a concentration of less than 0.5%. Alternatively or additionally, in some embodiments the composition includes tall oils at a total concentration of less than 0.5%. Alternatively or additionally, in some embodiments the composition includes chloride at a total concentration of at least 100 PPM. In some exemplary embodiments of the invention, there is provided a method including: (a) providing a composition as described herein, and (b) converting at least a portion of lignin in the composition to a conversion product. In some embodiments, the converting includes treating with hydrogen. Alternatively or additionally, in some embodiments the method includes producing hydrogen from lignin. Alternatively or additionally, in some embodiments the conversion product includes at least one item selected from the group consisting of bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, phenols, toluenes, and xylenes. Alternatively or additionally, in some embodiments the conversion product includes a fuel or a fuel ingredient. Alternatively or additionally, in some embodiments the conversion product includes para-xylene. Alternatively or additionally, in some embodiments the the converting includes aqueous phase reforming (APR). Alternatively or additionally, in some embodiments the converting includes at least one reaction type selected from the group consisting of catalytic hydrotreating and catalytic condensation. Alternatively or additionally, in some embodiments the converting includes at least one reaction type selected from the group consisting of zeolite catalyzed acid condensation (e.g. ZSM-5), base catalyzed condensation, hydrogenation, dehydration, alkene oligomerization and alkylation (alkene saturation). Alternatively or additionally, in some embodiments includes the converting occurs in at least two stages. In some embodiments, a first stage includes aqueous phase reforming. Alternatively or additionally, in some embodiments a second stage includes at least one of catalytic hydrotreating and catalytic condensation. Alternatively or additionally, in some embodiments the method is characterized by a hydrogen consumption of less than 0.07 ton per ton of product.

In some exemplary embodiments of the invention, there is provided a method including: (a) producing hydrogen from lignin in a first reaction; (b) treating additional lignin to form an intermediate product; and (c) converting the intermediate product to a conversion product; wherein at least one of the treating and converting includes contacting with at least a portion of the hydrogen. In some exemplary embodiments of the invention, the treating includes reducing an amount of ash in the intermediate product. Alternatively or additionally, in some embodiments the first reaction includes at least one reaction type selected from the group consisting of aqueous phase reforming (APR), pyrolysis and gasification. Alternatively or additionally, in some embodiments the intermediate product includes a liquid includes at least 20% lignin by weight (on an as is basis) and has a sulfur concentration of less than 0.07% by weight (on a dry matter basis). Alternatively or additionally, in some embodiments the treating includes at least one reaction type selected from the group consisting of hydrogenolysis, hydrogenation, pyrolysis, dissolution in an organic solvent and dissolution in an alkaline solution. Alternatively or additionally, in some embodiments the converting occurs in at least two stages. In some embodiments, a first stage includes aqueous phase reforming. Alternatively or additionally, in some embodiments a second stage includes at least one of catalytic hydrotreating and catalytic condensation. Alternatively or additionally, in some embodiments the converting includes aqueous phase reforming (APR). Alternatively or additionally, in some embodiments the converting includes at least one reaction type selected from the group consisting of zeolite catalyzed acid condensation (e.g. ZSM-5), base catalyzed condensation, hydrogenation, dehydration, alkene oligomerization and alkylation (alkene saturation). Alternatively or additionally, in some embodiments the method includes consuming an additional portion of the hydrogen during the converting. Alternatively or additionally, in some embodiments the method has a hydrogen consumption of less than 0.07 ton per ton of product. Alternatively or additionally, in some embodiments the converting yields a product with an O/C ratio <1 with carbon yield of at least 50%. Alternatively or additionally, in some embodiments the converting yields a product with an O/C ratio <1 with weight yield of at least 70%. In some exemplary embodiments of the invention, there is provided a conversion product produced as described herein, a consumer product produced from the conversion product or a consumer product containing the conversion product as an ingredient or component. In some exemplary embodiments of the invention, the product has at least one of: (i) a sulfur concentration of less than 0.07% by weight; (ii) soluble sugar content of less than 1 by weight; (iii) a phosphorus concentration of less than 100 PPM; (iv) total ash at a concentration of less than 0.5% wt; (v) tall oils at a total concentration of less than 0.5%; and (vi) less than 0.1 times the amount of volatile sulfur compounds found in Kraft lignin. Alternatively or additionally, in some embodiments the product includes at least one chemical selected from the group consisting of lignosulfonates, bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene and pharmaceuticals. In some embodiments, the product includes para-xylene. Alternatively or additionally, in some embodiments the product is selected from the group consisting of dispersants, emulsifiers, complexants, flocculants, agglomerants, pelletizing additives, resins, carbon fibers, active carbon, antioxidants, liquid fuel, aromatic chemicals, vanillin, adhesives, binders, absorbents, toxin binders, foams, coatings, films, rubbers and elastomers, sequestrants, fuels, and expanders. Alternatively or additionally, in some embodiments the product is used in an area selected from the group consisting of food, feed, materials, agriculture, transportation and construction. Alternatively or additionally, in some embodiments the product has a ratio of carbon-14 to carbon-12 of about 2.0×10⁻¹³ or greater. Alternatively or additionally, in some embodiments the product includes as described herein and an ingredient produced from a raw material other than lignocellulosic material. Alternatively or additionally, in some embodiments the ingredient as described herein and the ingredient produced from a raw material other than lignocellulosic material are essentially of the same chemical composition. Alternatively or additionally, in some embodiments the product includes a marker molecule at a concentration of at least 100 ppb. In some embodiments, the marker molecule includes PPM of furfural, products of their condensation, color compounds, acetic acid, methanol, galcturonic acid, glycerol, fatty acids and resin acids.

In some exemplary embodiments of the invention, there is provided a method including: (a) hydrolyzing a lignocellulosic substrate to produce polymeric solid lignin; and (b) liquefying the solid lignin to form a liquid includes at least 20% lignin by weight (on an as is basis) and having a sulfur concentration of less than 0.07% by weight (on a dry matter basis). In some embodiments, the liquefying includes de-polymerizing the polymeric lignin. Alternatively or additionally, in some embodiments the liquefying includes at least one action selected from the group consisting of contacting the lignin with an alkaline solution, contacting the lignin with an organic solvent, pyrolysis, gasification, hydrogenolysis, oxidation, reduction, base-catalyzed depolymerization and hydrolysis. In some embodiments, the liquefying includes hydrogenolysis. Alternatively or additionally, in some embodiments the polymeric solid lignin is produced as an acidic stream and the method includes: contacting the stream with an S1 solvent to produce solvent containing lignin; dissolving the solvent containing lignin in a basic solution (pH>9); and separating the solvent from the basic solution. Alternatively or additionally, in some embodiments the liquefying includes contacting the solid lignin with both a basic solution and a solvent. Alternatively or additionally, in some embodiments the liquefying includes contacting with a basic solution (pH≥9) at a temperature ≥120° C. Alternatively or additionally, in some embodiments ammonia or an ammonium salt is used to achieve pH≥9. Alternatively or additionally, in some embodiments the liquefying includes contacting with an organic solvent. In some embodiments, the organic solvent includes at least one member of the group consisting of mono-, di- or tri-oxygenates includes 2-6 carbons. Alternatively or additionally, in some embodiments the organic solvent is a product of an aqueous phase reforming reaction (APR). Alternatively or additionally, in some embodiments the method includes, performing APR on the liquid. Alternatively or additionally, in some embodiments the liquefying includes removal of at least a portion of ash from the solid lignin.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) are W/W (weight per weight) unless otherwise indicated. In addition, percentages are expressed on a dry matter basis unless otherwise indicated.

As used in this specification and the accompanying claims the terms “solution” and “suspension” indicate the presence of at least one solute in at least one solvent. In the case of a suspension, a portion of the solute may (in some cases) be dissolved in the solvent in addition to the portion that is suspended in the solvent. For example, successive addition of sugar to water will eventually produce a solution containing dissolved sugar at a high concentration which is also a suspension of undissolved sugar crystals. In other cases, a suspension is just a suspension. For example, adding sand to water produces only a suspension of sand grains, with virtually no dissolved sand.

Unless otherwise indicated, as used in this specification and the accompanying claims, the term “lignin” indicates any material including p-coumaryl alcohol and/or coniferyl alcohol and/or sinapyl alcohol, and/or short oligomers thereof and/or polymers thereof. Thus “lignin” includes solid polymeric lignin as well as partially or fully dissolved lignin.

As used in this specification and the accompanying claims the term “ash” refers to inorganic compounds, such as salts of alkali and alkaline-earth metals.

As used in this specification and the accompanying claims the term “reactive fluid” has the meaning ascribed to it in WO 2010/009343; paragraph [0058]:
“The term “reactive fluid” used herein means a fluid that is at a temperature higher than the boiling point of the liquid state of the fluid under atmospheric pressure (1 atm). The reactive fluid may be a liquid, a gas, a supercritical fluid, or a mixture of these. For example, water at a temperature above 100° C. and under atmospheric pressure is considered a reactive fluid. Supercritical, near critical, and sub-critical fluids are reactive fluids, illustrative examples including but not limited to sub-critical water, near critical water, supercritical water, supercritical ethanol, and supercritical CO₂.”

WO 2010/009343 is fully incorporated herein by reference.

“Aqueous-Phase Reforming” or “APR” indicates a catalytic reforming process that generates hydrogen-rich fuels from oxygenated compounds derived from biomass (e.g. glycerol, sugars, sugar alcohols, etc.). Various APR methods and techniques are described in U.S. Pat. Nos. 6,699,457; 6,953,873; 6,964,757; 6,964,758; 7,618,612 and PCT/US2006/048030; each of which is fully incorporated herein by reference. As used in this specification and the accompanying claims the terms “aqueous phase reforming” and “APR” generically denote the overall reaction of an oxygenated compound and water to yield a hydrogen stream, regardless of whether the reactions takes place in the gaseous phase or in the condensed liquid phase. “APR hydrogen” indicates hydrogen produced by the APR process. APR converts input oxygenated compounds to products including, but not limited to alcohols, ketones, aldehydes, alkanes, organic acids and furans.

Lignin decomposition products (LDPs) can be produced, for example, by pyrolysis and/or hydrogenolysis and/or oxidation and/or contact with a super-critical (or near super-critical) fluid such as water and/or another solvent or a mixture thereof. Exemplary methods for production of LDPs are reviewed by Pandey and Kim in “Lignin Depolymerization and Conversion: A Review of Thermochemical Methods” (Chem. Eng. Technol. (2011) 34 (1): 29-41) which is fully incorporated herein by reference. As used in this specification and the accompanying claims, the term “LDP” includes, but is not limited to phenols (e.g. phenol, catechol, guaiacol, syringol and cresol), aldehydes (e.g. vanillin and syringaldehyde) and aliphatics (e.g. methane, ethane and branched alkanes). As used in this specification and the accompanying claims the term LDP specifically excludes p-coumaryl alcohol, coniferyl alcohol and sinapyl alcohol which are “lignin”.

As used in this specification and the accompanying claims the term “S1” or “S1 solvent” or “first organic solvent” refers to a solvent which is less than 15% soluble in water and has a polarity related component of Hoy's cohesion parameter (delta-P) between 5 and 10 MPa^{1/2} and/or a hydrogen-bond related component of Hoy's cohesion parameter (delta-H) between 5 and 20 MPa^{1/2}. Optionally, S1 includes an alcohol, ketone or aldehyde with 5, optionally 6, or 8 or more carbon atoms. Optionally, S1 includes a hexanol, a heptanol or an octanol such as 2-ethyl-hexanol and combinations thereof.

Delta-P is the polarity related component of Hoy's cohesion parameter and delta-H is the hydrogen bonding related component of Hoy's cohesion parameter.

The cohesion parameter, as referred to above or, solubility parameter, was defined by Hildebrand as the square root of the cohesive energy density:

$$δ = \sqrt{\frac{Δ {E}_{vap}}{V}}$$

where ΔEvap and V are the energy or heat of vaporization and molar volume of the liquid, respectively. Hansen extended the original Hildebrand parameter to a three-dimensional cohesion parameter. According to this concept, the total solubility parameter, delta, is composed of three different components, or, partial solubility parameters relating to the specific intermolecular interactions:

δ²=δ_{d}²+δₚ²+δₕ²

in which delta-D, delta-P and delta-H are the dispersion, polarity, and Hydrogen bonding components, respectively. Hoy proposed a system to estimate total and partial solubility parameters. The unit used for those parameters is MPa^{1/2}. A detailed explanation of that parameter and its components can be found in “CRC Handbook of Solubility Parameters and Other Cohesion Parameters”, second edition, pages 122-138. That and other references provide tables with the parameters for many compounds. In addition, methods for calculating those parameters are provided.

Exemplary S1 solvents include, but are not limited to, alcohols, ketones or aldehydes with 5, optionally 6, or 8 or more carbon atoms. Optionally, S1 includes a hexanol, a heptanol or an octanol such as 2-ethyl-hexanol and combinations thereof.

As used in this specification and the accompanying claims the term “volatiles” indicates materials which evaporate or sublime from a sample after incubation for five hours at a given temperature. A “volatiles content” for a given temperature can be determined by weighing the sample before and after the incubation.

As used in this specification and the accompanying claims the term “volatile sulfur compounds” indicates those sulfur compounds detectable by GCMS (Gas Chromatographic Mass Spectography) from the headspace of a closed container in which a sample is incubated at 150° C. Lignin compositions according to some exemplary embodiments of the invention contain substantially no volatile sulfur compounds.

As used in this specification and the accompanying claims the terms “soluble carbohydrates” and “soluble sugars” are equivalent.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic representation of a system for hydrolysis of lignocellulosic material;

FIG. 2 is a series of scanning electron micrographs (SEM) of lignin according to various exemplary embodiments of the invention: panels a, b and c depict a <200 mesh sieved fraction; panels d, e and f depict the same <200 mesh sieved fraction further treated with H₂SO₄; panels g, h, i and j depict the same <200 mesh sieved fraction further treated with HCl; panels k, l and m depict the same <200 mesh sieved fraction further treated enzymatically;

FIG. 3 is a series of scanning electron micrographs (SEM) (panels a through e) of lignin prepared according to the previously known Kraft process;

FIG. 4 is a differential scanning calorimetry (DSC) plot depicting heat flow in W/g as a function of temperature in degrees centigrade;

FIG. 5 is a scanning electron micrograph (SEM) of lignin with measurements of pore width superimposed;

FIG. 6 is a simplified flow diagram of a method according to some exemplary embodiments of the invention;

FIG. 7 is a simplified flow diagram of a method according to some exemplary embodiments of the invention;

FIG. 8 is a simplified flow diagram of a method according to some exemplary embodiments of the invention;

FIG. 9 is a simplified flow diagram of a method according to some exemplary embodiments of the invention;

FIG. 10 is a simplified flow diagram of a method according to some exemplary embodiments of the invention;

FIG. 11 is photograph of re-solidified lignin produced by injecting lignin in solution into an anti-solvent;

FIG. 12 is a simplified flow diagram of a method according to some exemplary embodiments of the invention;

FIG. 13 is a schematic representation of a lignin conversion system according to some exemplary embodiments of the invention;

FIG. 14 is a simplified flow diagram of a method according to some exemplary embodiments of the invention;

FIG. 15 is a schematic representation of a lignin conversion system according to some exemplary embodiments of the invention;

FIG. 16 is a simplified flow diagram of a method according to some exemplary embodiments of the invention; and

FIG. 17 is a schematic representation of an integrated sugar and lignin conversion system according to some exemplary embodiments of the invention;

FIG. 18 is a schematic representation of lignin purification system according to some exemplary embodiments of the invention; and

FIG. 19 is a simplified flow diagram of a method according to some exemplary embodiments of the invention.

### DETAILED DESCRIPTION OF EMBODIMENTS

Some embodiments of the invention relate to lignin compositions, products comprising those compositions, lignin formulations, methods to produce lignin compositions, and spinning methods which produce fibers from lignin.

Some embodiments of the invention, relate to methods to produce lignin compositions, lignin compositions produced by those methods, lignin conversion methods, products of such conversions and products of such conversion products.

Specifically, some embodiments of the invention can be used to produce para-xylene and/or liquid fuel and/or carbon fibers from lignin.

The principles and operation of a methods and/or compositions and/or products and/or fibers according to exemplary embodiments of the invention may be better understood with reference to the drawings and accompanying descriptions.

It is to be understood that the invention is not limited in its application to the details set forth in this description. The invention is capable of other embodiments or of being practiced or carried out in various ways. Also, it is to be understood that the phraseology and terminology employed herein is for the purpose of description and should not be regarded as limiting unless a closed definition of a specific term or phrase is provided.

### Exemplary System Overview

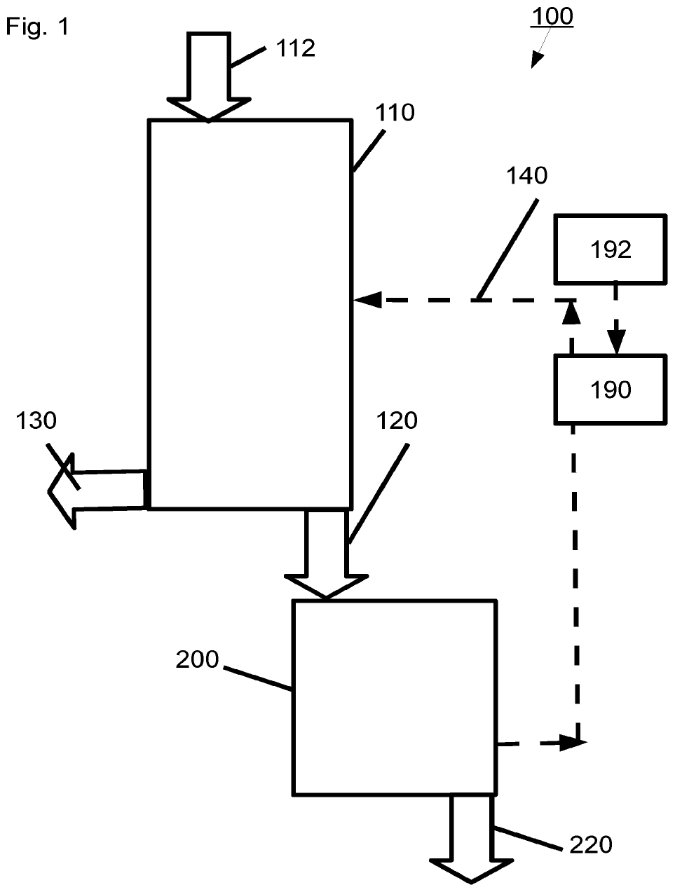

FIG. 1 is a schematic overview of an exemplary industrial context of some embodiments of the invention depicting relevant portions of an acid hydrolysis system for processing of lignocellulosic material indicated generally as 100. Depicted system 100 includes a hydrolysis vessel 110 which takes in lignocellulosic substrate 112 and produces two exit streams. The first exit stream is an acidic hydrolyzate 130 containing an aqueous solution of HCl with dissolved sugars. Other mineral acids (e.g. H₂SO₄) may also be used in addition to or in place of HCL in any of the embodiments described herein. The second exit stream 120 is a lignin stream. Lignin compositions containing lignin from stream 120 comprise some exemplary embodiments of the invention. According to various exemplary embodiments of the invention one or more characteristics of lignin in stream 120 are controlled by including hardwood and/or softwood in substrate 112.

Optionally, hydrolysis vessel 110 is of a type described in co-pending application PCT/US2011/057552 filed Oct. 24, 2011 entitled “Hydrolysis Systems and Methods” which is fully incorporated herein by reference.

Alternatively or additionally, hydrolysis vessel 110 may include hydrolysis reactors of one or more other types.

FIG. 1 indicates that processing of lignin stream 120 occurs in lignin processing module 200 and produces lignin 220 which is substantially free of residual HCl and/or water and/or soluble carbohydrates. Optionally, lignin processing module 200 includes two or more sub-modules. For purposes of the overview of system 100, it is sufficient to note that module 200 produces a re-cycled stream 140 of concentrated HCl which is routed to hydrolysis vessel 110. In some exemplary embodiments of the invention, HCl gas 192 is added to stream 140 by means of an absorber 190. Optionally, the HCl gas is also produced by module 200.

Exemplary modules 200 are described in detail in co-pending application PCT/IL 2011/000424 filed on Jun. 1, 2011 by Robert JANSEN et al. and entitled “LIGNIN COMPOSITIONS, SYSTEMS AND METHODS FOR PROCESSING LIGNIN AND/OR HCl” which is fully incorporated herein by reference.

The present application deals with various ways to convert lignin 220 into a conversion product. In some embodiments, the conversion product is a fuel or fuel component. In other embodiments of the invention, the conversion product is a chemical intermediate (e.g. para-xylene). Para-xylene is used commercially on a for the manufacture of terephthalic acid for polyester.

In some embodiments, converting lignin 220 begins with liquefying the lignin. Optionally, the liquefaction includes depolymerization and/or hydrogenolysis.

Alternatively or additionally, in some embodiments, converting lignin 220 includes generation of hydrogen. According to various embodiments of the invention, generation of hydrogen is by pyrolysis and/or gasification.

### Exemplary Lignin Compositions

Various exemplary embodiments of the invention relate to lignin compositions provided as a solution in a main solvent and to solid compositions produced therefrom. In some embodiments, the solid compositions include fibers.

Some embodiments of the invention relate to lignin compositions including a liquid including at least 20%, 30%, 40% or even 50% or more lignin by weight (on an as is basis) and having a sulfur concentration of less than 0.07%, 0.05%, 0.025%, or even 0.01% or less by weight (on a dry matter basis).

Liquefaction of lignin can make it more amenable to various conversion reactions which will be mentioned below. Alternatively or additionally, a low ash content, especially a low sulfur and/or phosphorous concentration can make the lignin more suitable for use in catalytic reactions by contributing to a reduction in catalyst fouling and/or poisoning.

The concentration of sulfur, and other contaminants discussed below is relative to the solution. The percentage relative to the lignin will be proportionally higher (e.g. 5 times higher for 20% lignin solution).

According to these embodiments the liquid is typically a single liquid phase (although the composition may still contain another phase), the lignin is mostly dissolved in that liquid and its content there is at least 20, or at least 30, or at least 40, or at least 50% wt on an as is basis. In some embodiments, the liquid includes at least 90% by weight of the total lignin present.

According to various exemplary embodiments of the invention the sulfur content is less than 0.05%, less than 0.03%, less than 0.02%, less than 0.01%, less than 0.005 or even less than 0.002.

In some embodiments, the lignin has a formula of C₉H_{X}O_{Y}; wherein X is at least 9 and Y is less than 5.

According to various exemplary embodiments of the invention Y is less than 3, less than 2.5, or even less than 2.

The indicated percentage of lignin in the liquid is dissolved, although an additional amount of solid lignin may be dispersed in the liquid. In some embodiments there is an advantage to have only a low amount of solid lignin, more preferably substantially no solid lignin. In some embodiments, the lignin in solution is at least partially depolymerized. In such cases an assay may indicate monomers of phenolic compounds which are indicative of the lignin or oligomers thereof.

In some embodiments, the composition includes less than 1% by weight soluble sugars. In other exemplary embodiments of the invention, the amount of soluble sugars is less than 0.5% or less than 0.1%.

Alternatively or additionally, the composition includes phosphorus at a concentration of less than 100 PPM. According to various exemplary embodiments of the invention the composition includes phosphorus at a concentration of less than 50 PPM, less than 25 PPM, less than 10 PPM, less than 1 PPM, less than 0.1 PPM, or even less than 0.01 PPM.

Alternatively or additionally, in some embodiments, the lignin has an oxygen to carbon (0/C) ratio less than 0.34. In some embodiments of the invention, the O/C ratio is less than 0.3 or even less than 0.25.

In some embodiments, the lignin has a hydrogen to carbon H/C ratio less than 2. In some embodiments of the invention, the H/C ratio is less than 1.5 or even less than 1.25.

Alternatively or additionally, the lignin is dissolved in alkaline solution (pH ≥9.0 or pH ≥9.5) or suspended/dispersed such a solution. Such solutions can contain alkaline bases and/or alkaline earth bases and/or ammonia and/or ammonia salts. In some embodiments, the alkaline solution includes a combination of NaOH and ammonia. Phenolic monomers resulting from dissolution of lignin are considered lignin for purposes of this specification and the accompanying claims. Optionally anthraquinone is added to the alkaline solution. In some embodiments, addition of anthraquinone contributes to an increase in solubility of the lignin. In some embodiments, ammonia is recovered from the alkaline solution for re-use. Optionally the recovery includes distillation. Alternatively or additionally, excess ammonia is included in the alkaline solution to contribute to ease of distillation.

Alternatively or additionally, the composition includes an organic solvent.

In some embodiments, the organic solvent results from aqueous-phase reforming (APR) of carbohydrates and/or lignin and/or a lignin decomposition product (LDP).

According to various exemplary embodiments of the invention, lignin decomposition includes one or more of pyrolysis, hydrogenolysis, oxidation and contact with water or solvent in a super-critical condition or near super-critical condition. The LDP can be, for example, one or more of pyrolitic oils and monomeric phenols.

Optionally, the lignin is contacted with one or more APR products prior to, or during decomposition (See the white paper entitled “Conventional liquid fuels from sugars” by P. G. Bommel and R. D. Cortright (Aug. 25, 2008) for a description of APR products).

For example, APR products include C2-C6, mono- or di- or tri-oxygenates, optionally ones with water solubility of >10%. In some embodiments, the APR products include alcohols and/or ketones and/or aldehydes and/or alkanes and/or organic acids and/or furans.

Without reference to APR, in some embodiments, organic solvent includes one or more of an alcohol, a ketone, an aldehyde, an alkane, an organic acid and a furan of 6 carbons or less.

In some embodiments, the composition includes a product of an aqueous-phase reforming reaction (APR). In some embodiments, the product of an APR is the result of APR conducted on a substrate including one or more of a carbohydrate, lignin and a lignin decomposition product (LDP).

In some embodiments, product of an APR is the result of APR conducted on a substrate which does not include carbohydrates.

In some embodiments, the composition includes at least one LDP selected from the group consisting of a pyrolytic oil, a phenol, an aldehyde and an aliphatic compound.

In some exemplary embodiments of the invention, at least 10% of the lignin in the lignin composition has a molecular weight of less than 10 kDa. According to various exemplary embodiments of the invention this percentage can is at least 20, 30, 40 or 50%.

Alternatively or additionally, in some embodiments, at least 10, 20, 30, 40 or 50% of the lignin has a molecular weight of less than 5 kDa.

Alternatively or additionally, in some embodiments, at least 10, 20, 30, 40 or 50% of the lignin has a molecular weight of less than 3 kDa.

Alternatively or additionally, in some embodiments, at least 10, 20, 30, 40 or 50% of the lignin has a molecular weight of less than 1 kDa.

Alternatively or additionally, in some embodiments, at least 10, 20, 30, 40 or 50% of the lignin has a molecular weight of less than 0.5 kDa.

In some embodiments, at least 10% of the lignin in the composition has a molecular weight in the range between 0.2 kDa and 5 kDa. According to various exemplary embodiments of the invention this percentage is at least 20, 30, 40 or 50%.

In some embodiments, the composition includes at least 10 ppm of an S1 solvent. Alternatively or additionally, in some embodiments the composition includes at least 10 ppm of at least one marker molecule, two marker molecules, three marker molecules, four marker molecules or five marker molecules. According to various exemplary embodiments of the invention marker molecules include, but are not limited to furfurals, alkyl chloride with 6-10 carbon atoms, tall oils and resin acids.

In some embodiments, the composition includes cellulose. In those embodiments including cellulose, the percentage of cellulose is 1, 3, 5, 10, 20 or even 30% or intermediate or greater percentages. Alternatively or additionally, the composition includes one or more furfurals at a total concentration of at least 10 PPM, at least 25 PPM, at least 50 PPM, or at least 100 PPM. In some embodiments, the furfurals include hydroxymethyl furfural. As used in this specification and the accompanying claims the term “furfurals” includes furfurals per se as well as furfural condensation products and oligomers of 3 to 10 furfural units.

In some embodiments, the composition includes ash at a concentration of less than 0.5%, less than 0.4%, less than 0.3%, less than 0.2%, less than 0.1%, less than 0.05% or even less than 0.01%.

In some embodiments, the composition includes tall oils at a total concentration of less than 0.5%, less than 0.25% or even less than 0.1%. Alternatively or additionally, In some embodiments, the composition includes chloride at a total concentration of at least 100 ppm. In some embodiments, the chloride concentration is 200, 400, or 600 ppm or intermediate or greater concentrations.

### Exemplary High Purity Lignin Compositions

Some exemplary embodiments of the invention, relate to a lignin composition including less than 10%, 7%, 5%, 3%, 2% or even less than 1% non-lignin material.

In some embodiments, such a composition has an ash content of ≤1%, ≤0.5%, ≤0.1% or even ≤0.025%.

Alternatively or additionally, in some embodiments, such a composition has a total carbohydrate content of ≤1%, ≤0.5%, ≤0.05% ≤0.05%, ≤0.025% or even ≤0.01%.

Alternatively or additionally, in some embodiments, such a composition has a non melting particulate content (>1 micron diameter) of ≤1%, ≤0.5%, ≤0.1%, ≤0.5%, ≤0.1% or even ≤0.05%. Particles smaller than 1 micron diameter are not considered when calculating the percentage. As used here the phrase “non melting” indicates particles which do not melt at 150° C. In some exemplary embodiments of the invention, the particles do not melt at 150° C., 175° C., 200° C., 225° C. or even 250° C. or intermediate or greater temperatures

Alternatively or additionally, in some embodiments, such a composition has a volatiles content of ≤5%, ≤4%, ≤3%, ≤2%, or ≤1% (at 200° C.).

Alternatively or additionally, in some embodiments the composition includes a chloride (Cl) content of less than 1%; less than 0.5%; or even less than 0.1%.

Alternatively or additionally, in some embodiments the composition includes a sulfur content of less than 0.07%; less than 0.05% or even less than 0.025%.

Alternatively or additionally, in some embodiments the composition includes a sulfur content of less than 70 PPM; less than 50 PPM or even less than 25 PPM.

Alternatively or additionally, in some embodiments the composition includes a phosphorus content of less than 100 PPM; less than 50 PPM or even less than 25 PPM.

Alternatively or additionally, in some embodiments the composition includes a soluble carbohydrate content of less than 5%; less than 2.5% or even less than 1%.

This Type of Composition is Amenable to a Wide Variety of Uses Including, but not Limited to, Production of Lignin Fibers and/or Carbon Fibers. Exemplary Characteristics of Lignin Compositions

In some exemplary embodiments of the invention, a lignin composition has (on a dry matter basis) one, two, three, four, or even five or more features presented in this section.

In some embodiments, the composition has a formula of C₉H_{X}O_{Y}; wherein X is at least 9 and Y is less than 5, less than 4, less than 3, less than 2.5, or less than 2.

In some embodiments, the composition has a chloride (Cl) content of at least 0.1%, at least 0.2%, at least 0.5%, 1%, 2%, or 5%, or intermediate or greater percentages.

Alternatively or additionally, in some embodiments the composition has a chloride (Cl) content of less than 1%, less than 0.8%, less than 0.5% or intermediate or lower percentages.

Alternatively or additionally, in some embodiments the composition has a chloride (Cl) content of at least 10 PPM, at least 25 PPM, at least 50 PPM, at least 100 PPM or intermediate or higher concentrations.

Alternatively or additionally, in some embodiments the composition has a covalently bound chlorine (Cl) content of at least 1 PPM, optionally at least 10 PPM, optionally at least 25 PPM, optionally at least 50 PPM, optionally at least 100 PPM or intermediate or higher concentrations.

In some embodiments, the composition has an O/C ratio of less than 0.34 optionally less than 0.3, optionally less than 0.25 or intermediate or lower ratios.

Alternatively or additionally, in some embodiment the composition has an O/C ratio less than previously reported for lignin from a same specific lignocellulosic source.

In some embodiments, the composition has an H/C ratio less than 2.

In some embodiments, the composition has a solubility of less than 30%, less than 20% or even less than 15% in DMSO (dimethylsulfoxide) at room temperature after high shear mixing.

In some embodiments, the composition has a solubility of less than 20%, less than 15% or even less than 10% in DMF (dimethylformamide) at room temperature after high shear mixing.

In some embodiments, the composition has an ash content of less than 0.5%, less than 0.4%, less than 0.3%, less than 0.2%, or even less than 0.1% or intermediate or lower percentages.

In some embodiments, the composition has a sulfur content of less than 0.07%, less than 0.05%, less than 0.03%, less than 0.02%, or even less than 0.01% or intermediate or lower percentages.

In some embodiments, the composition has a phosphorus content of less than 100 PPM, less than 50 PPM, less than 25 PPM, less than 10 PPM, less than 1 PPM, less than 0.1 PPM, or even less than 0.01 PPM or intermediate or lower concentrations.

In some embodiments, the composition has a soluble carbohydrate content of less than 5%, less than 3%, less than 2%, or even less than 1% or intermediate or lower percentages.

In some embodiments, the composition has a marker molecule, two or more marker molecules, three or more marker molecules or four or more marker molecules having content of at least 10 PPM. Marker molecules include, but are not limited to furfural and hydroxymethyl furfural, products of their condensation, color compounds, acetic acid, methanol, galcturonic acid, glycerol, fatty acids and resin acids.

In some embodiments, the composition has a furfurals content of at least 10 PPM, at least 25 PPM, at least 50 PPM, at least 100 PPM or intermediate or higher In some embodiments, the composition has a detectable amount of hydroxymethyl furfural.

In some embodiments, the composition includes furfurals including oligomers of 3 to 10 furfural units.

In some embodiments, the composition has an LDP content including at least one member of the group consisting of a pyrolytic oil, a phenol, an aldehyde and an aliphatic compound.

In some embodiments, the composition has a lignin decomposition products (LDP) content of less than 1000 PPM, less than 500 PPM, or even less than 200 PPM or intermediate or lower concentrations.

In some embodiments, the composition has an LDP content of ≥100 PPB, ≥250 PPB, ≥500 PPB, or even ≥1 PPM.

In some embodiments, the composition has an S1 solvent content of at least 10 PPM, at least 20, at least 50, or even at least 100 PPM or intermediate or greater concentrations.

In some embodiments, the composition includes a lignin polymer bound to an alcohol of at least 6 carbons by an ether bond. Optionally, the composition includes at least 10 PPB of the lignin polymer bound to an alcohol of at least 6 carbon atoms by an ether bond

In some embodiments, the composition has a tall oil content of less than 0.5%, less than 0.25% or even less than 0.1% or intermediate or lower concentrations.

In some embodiments, the composition has a dry basis content of carboxylic functions greater than 0.05%, greater than 0.07% or even greater than 0.1%. As used in this specification and the accompanying claims the term “carboxylic” includes both carboxylic form (i.e. acid) and carboxylate form (i.e. salt).

The dry basis content of carboxylic functions is generally indicative of a degree of oxidation, with higher values indicating a higher degree of oxidation. In some embodiments, an increase in degree of oxidation of lignin contributes to an improvement in interaction with synthetic polymeric materials during compounding and/or contributes to a reduction in blooming of the compounded product. According to various exemplary embodiments of the invention various oxidizing reagents and/or oxidizing protocols are employed to achieve a desired degree of oxidation.

In some embodiments, at least 75%, at least 80, at least 85, at least 90, at least 95 or even at least 97.5% of lignin in the composition has a molecular weight (MW) greater than 50 kDa. As used in this specification and the accompanying claims the terms “molecular weight” and “MW” indicate weights as measured by gel permeation chromatography (GPC) in high precision liquid chromatography (HPLC) with reference to standards of known MW.

In some exemplary embodiments of the invention, lignin contains cellulose in the range of 20 to 25%. Optionally, this percentage can be reduced. Reduction strategies include, but are not limited to treatment with acid (e.g. HCl and/or H₂SO₄) and/or enzymatic treatment.

### Exemplary Physical Forms

In some exemplary embodiments of the invention the lignin composition(s) as described above are provided as a solid. In some embodiments, the solid includes lignin fibers.

In some exemplary embodiments of the invention the lignin composition(s) as described above are provided as a solution. Alternatively or additionally, in some embodiments the lignin composition(s) as described above are provided as a suspension. According to various exemplary embodiments of the invention the solvent in the solution and/or suspension includes water and/or a water-soluble solvent. In some embodiments, the solvent includes 7 to 15% ammonia and/or 2 to 5% peroxide in water. Alternatively or additionally, in some embodiments the solvent includes 2 to 5% of a strong base (e.g. NaOH) and/or 0.0005 to 0.002% anthraquinone in water.

### Exemplary Micro-Morphology of Lignin

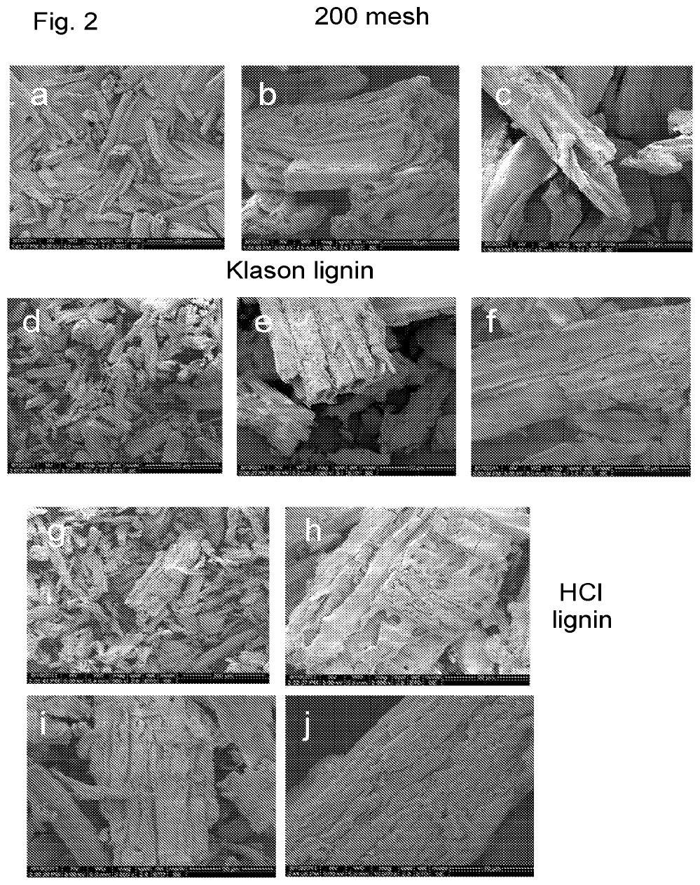

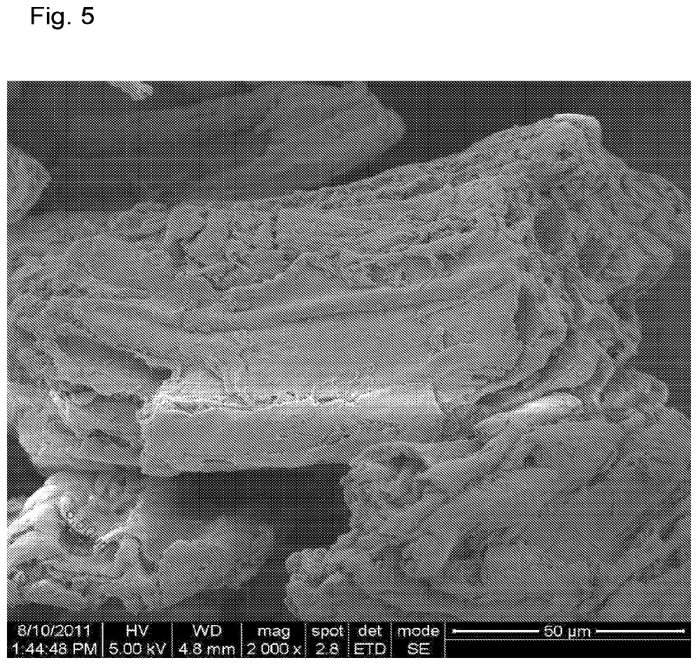

The micro-morphology of lignin according to various exemplary embodiments of the invention resembles wood (see FIG. 2). Specifically, in some exemplary embodiments of the invention, lignin includes pores or tubules. These pores/tubules are described herein in Example 10 with reference to FIG. 5.

Lignin according to exemplary embodiments of the invention milled with a Retsch ball mill mixer to <50 um size (i.e. 90% of the sample ≤40 um) still exhibited the wood structure. Specifically, the particles retain an elongated and/or flattened appearance.

In some exemplary embodiments of the invention, exhibits a softening point in the range of 130-250° C. In some embodiments, inclusion of hardwood in substrate 112 sharpens the softening point so that the lignin exhibits more melt-like behavior.

### Exemplary Lignin Products

In some exemplary embodiments of the invention, a lignin composition as described herein is provided as part of a product comprising other ingredients. Alternatively or additionally, in some embodiments, a lignin composition as described herein is used in preparation of another material or product. Examples of such materials/products include, but are not limited to, carbon fibers, protective coatings, lignosulfonates, bio-oils, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene, pharmaceuticals, dispersants, emulsifiers, complexants, flocculants, agglomerants, pelletizing additives, resins, antioxidants, liquid fuels, aromatic chemicals, vanillin, adhesives, binders, absorbents, toxin binders, foams, films, rubbers, elastomers, sequestrants, solid fuels, expanders a liquid fuels, paints, dyes, glues, plastics, wet spun fibers, melt spun fibers, flame retardants, activated carbon, activated carbon fibers, absorbent materials (e.g. in hygienic pads, diapers or wound dressings), phenol resins, phenols, terphthalates, epoxies, BTX (Benzene/Toluene/Xylene), polyols and polyolefins, each of which represents an additional exemplary embodiment of the invention.

Each of these materials/products represents an embodiment of the invention.

Alternatively or additionally, each of these materials or products can serve as a raw material for production of, and/or an ingredient in, other materials and/or products, each of which represents an additional exemplary embodiment of the invention.

In some exemplary embodiments of the invention, analysis of the amount of Cl, or covalently bound Cl, in a product provides an indication of the lignin source employed in its manufacture.

Alternatively or additionally, analysis of the amount of one or more marker molecules related to the lignin production process in a product may provide an indication of the lignin source employed in its manufacture. Exemplary marker molecules include, but are not limited to furfurals and/or S1 solvent residues. Optionally, furfurals maybe present as oligomers.

Alternatively or additionally, presence of an alcohol of at least 6 carbons bound to a lignin polymer by an ether bond in a product is indicative of the source of the lignin used to prepare the product.

Alternatively or additionally, analysis of the C/H/O ratio in a product provides an indication of the lignin source employed in its manufacture.

### Exemplary Paste and its Use

Some exemplary embodiments of the invention, relate to a viscous paste including a lignin composition as described above. Such a paste can serve as a base for paints or coatings. Such pastes or coating are expected to be characterized by high UV absorption and/or flame retardant activity and/or bacteriostatic and/or bactericidal activity (e.g. against soil bacteria).

Exemplary Formulations and their Use

Some exemplary embodiments of the invention, relate to lignin formulations.

In some embodiments, a lignin formulation includes finely milled solid lignin; and lignin in solution at a controlled concentration. Formulations of this type are expected to find utility as coatings, as an input material for wet spinning of fibers, in preparation of carbon based electrodes and/or battery electrodes, in construction of fuel cells, in preparation of hydrogen holding devices and in preparation of carbon filters.

In some embodiments, a lignin formulation includes lignin in solution at a controlled concentration and positively charged particles suspended in the solution. Optionally, the positively charged particles include metal oxides. Exemplary metal oxides suitable for use in such formulations include, but are not limited to TiO₂ and/or Al₂O₃. Optionally, formulations of soluble lignin with such positively charges particles form gels applicable as bonding materials and/or fillers. Alternatively or additionally, such gels can serve as an input in a gel spinning process.

### Exemplary Lignin Processing Methods

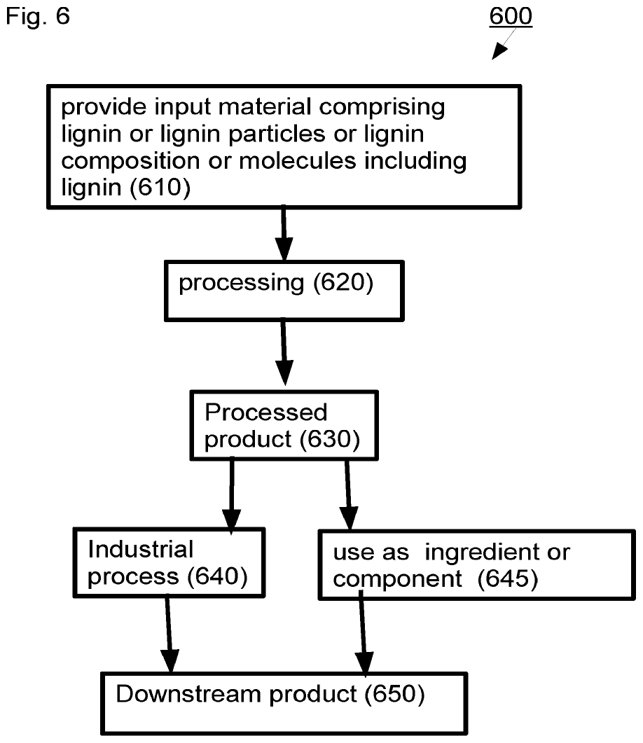

FIG. 6 depicts an exemplary method to process lignin into a product, indicated generally as 600. Depicted exemplary method 600 includes providing (610) an input material comprising lignin as described herein and/or lignin particles as described herein and/or a composition as described herein and/or molecules as described herein and processing (620) the input material to produce a processed product 630. Exemplary processed products 630 include, but are not limited to carbon fibers, activated carbon, activated carbon fibers, absorbent materials, coatings, phenol resins, adhesives, dispersants, flocculants, phenols, terphthalates, epoxies, BTX, liquid fuels, polyols and polyolefins.

Processed products 630 are exemplary embodiments of the invention.

FIG. 6 also depicts an exemplary method including providing a processed product 630 and subjecting processed product 630 to an industrial process 640 to produce a downstream product 650. Downstream products 650 include but are not limited to hygienic pads, diapers, wound dressings, sports equipment, structural components, paints and dyes.

Downstream products 650 are exemplary embodiments of the invention.

FIG. 6 also depicts an exemplary method including providing a processed product 630 and using 645 processed product 630 as an ingredient or component in a downstream product 650. Downstream products 650 include, but are not limited to liquid fuels, paints, dyes, glues and plastics. Downstream products 650 are exemplary embodiments of the invention.

### Exemplary Method to Make a Composition

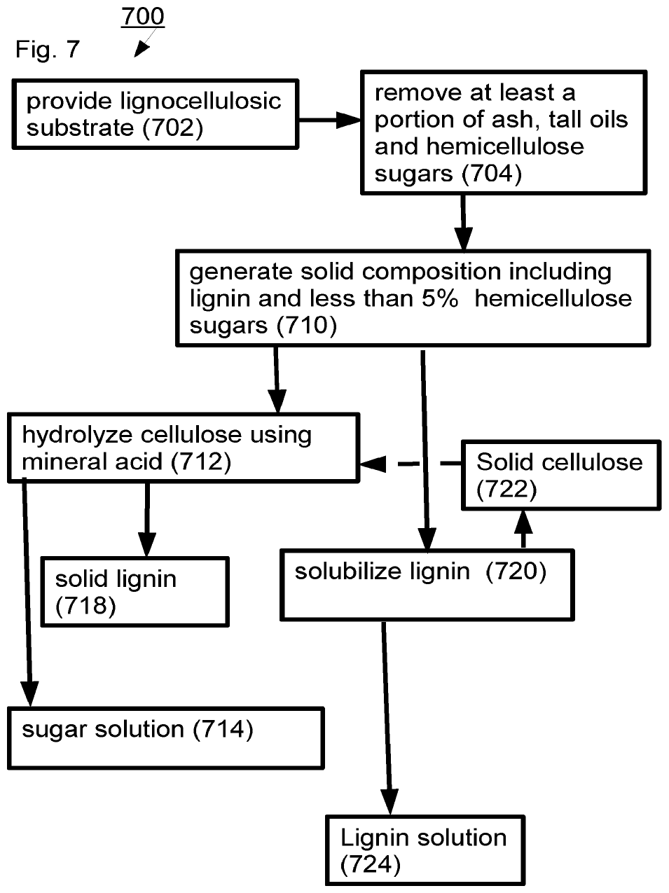

FIG. 7 is a simplified flow diagram of a method to prepare a lignin composition according to some exemplary embodiments of the invention indicated generally as method 700.

Depicted exemplary method 700 includes generating 710 a solid composition including lingnin and less than 5%, Optionally less than 3% optionally less than 1% hemicellulose sugars solubilizing 720 lignin in the composition to form a lignin solution 724. As used in this specification and the accompanying claims the term “hemicellulose sugars” refers to sugars indicative of hemicellulose, i.e. exylose, arabinose, mannose, galactose, mannuronic acid and galacturonic acid. According to various exemplary embodiments of the invention these hemicellulose sugars may be present as polymers and/or oligomers and/or monomers. Optionally, the polymers and/or oligomers include other sugars (e.g. glucose). Optionally, solubilizing 720 employs NaOH and/or anthraquinone and/or ammonia and/or peroxide as described herein.

In some exemplary embodiments of the invention, generating 710 includes providing 702 a lignocellulosic substrate and removing 704 at least a portion of ash, tall oils and hemicellulose sugars from said substrate. Removing 704 can be, for example, as described in co-pending application PCT/US2011/064237.

In some exemplary embodiments of the invention, the solid composition includes cellulose and solubilizing 720 the lignin leaves solid cellulose 722. Optionally, solid cellulose 722 is hydrolyzed (e.g. with a mineral acid at 712).

In other exemplary embodiments of the invention, the solid composition includes cellulose and method 700 includes hydrolyzing 712 the cellulose using a mineral acid solution to form a sugar solution 714 and solid lignin 718 and de-acidifying (not depicted) solid lignin 718. Solid lignin 718 can then be solubilized 720.

In some exemplary embodiments of the invention, hydrolysis 712 is performed with HCl concentration of 30 to 44% as determined from HCl/[HCl+water]. Exemplary systems and methods for de-acidification of solid lignin 718 are described in co-pending PCT application PCT/IL2011/000424.

### Exemplary Spinning Methods

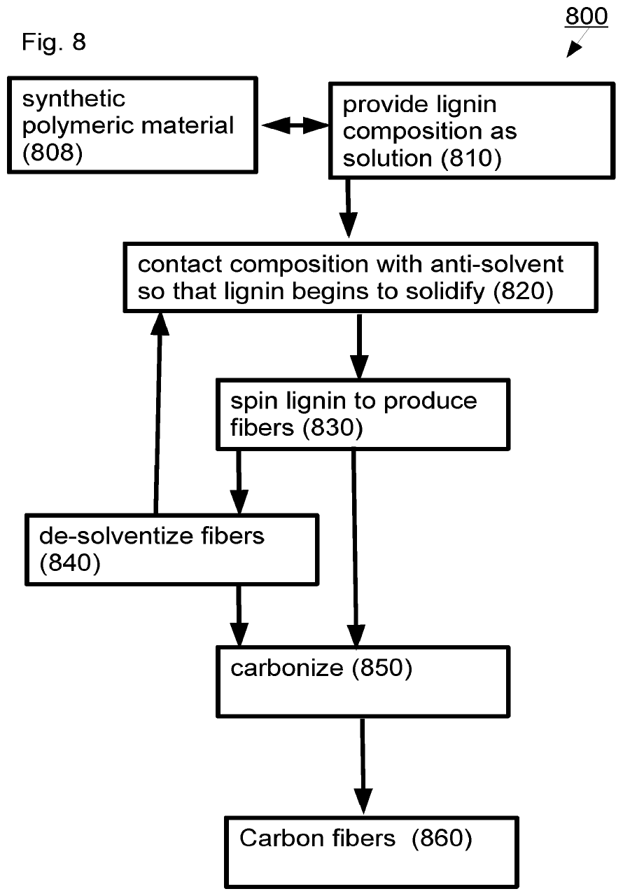

FIG. 8 is a simplified flow diagram of a wet spinning method according to some exemplary embodiments of the invention indicated generally as 800. Depicted exemplary method 800 includes providing 810 a lignin composition as described herein as a solution and spinning 830 the lignin to produce fibers of lignin.

Some embodiments of depicted exemplary method 800 include de-solventizing 840 the fibers. De-solventizing 840 includes removing the antisolvent (e.g. acidified ethanol) from the fibers and/or removing any main solvent remaining from the solution provided at 810. In some embodiments, antisolvent is removed by drying. In some embodiments, de-solventizing 840 occurs as the fibers are formed.

In some embodiments, method 800 includes contacting 820 the composition with an anti-solvent so that the lignin begins to solidify as depicted. Alternatively or additionally, in some embodiments the antisolvent is recovered and re-used at contacting 820 as depicted.

In some exemplary embodiments of the invention, method 800 includes mixing a synthetic polymeric material (e.g., polypropylene and/or polyacrylonitrile (PAN)) (808) with the lignin composition provided at 810. According to these embodiments, spinning at 830 produces fibers which are a mixture of lignin and synthetic polymeric material 808. According to various exemplary embodiments of the invention the fibers have a lignin: synthetic polymer (e.g. PAN) ratio between 1:10 and 10:1.

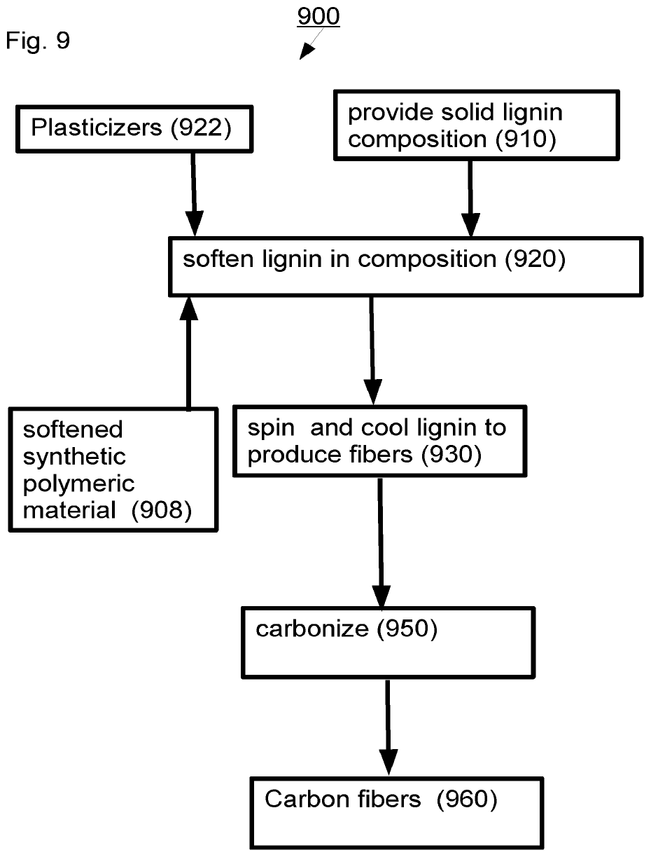

FIG. 9 is a simplified flow diagram of a melt spinning method according to some exemplary embodiments of the invention indicated generally as 900. Depicted exemplary method 900 includes providing 910 a lignin composition as a solid (e.g. milled, ground or powdered form) and softening (optionally melting) 920 lignin in the composition. In the depicted exemplary embodiment, method 900 includes spinning and cooling 930 the lignin to produce fibers of lignin. In some embodiments of method 900, melting 920 is conducted in the presence of plasticizers 922 as depicted. In some embodiments, providing 910 includes hydrolysis of a lignocellulosic substrate. In some embodiments, the substrate includes a hardwood (e.g. eucalyptus). In some embodiments, the substrate includes a mixture of hardwood and softwood (e.g. pine). In other exemplary embodiments of the invention, the substrate includes only hardwood. In other exemplary embodiments of the invention, the substrate includes only softwood.

Alternatively or additionally, in some exemplary embodiments of the invention, method 900 includes mixing a softened (optionally melted) synthetic polymeric material 908 with the lignin softened at 920. In some embodiments, the lignin and synthetic polymeric material 908 are softened (optionally melted) together at 920. According to these embodiments, spinning at 930 produces fibers which are a mixture of lignin and synthetic polymeric material 908.

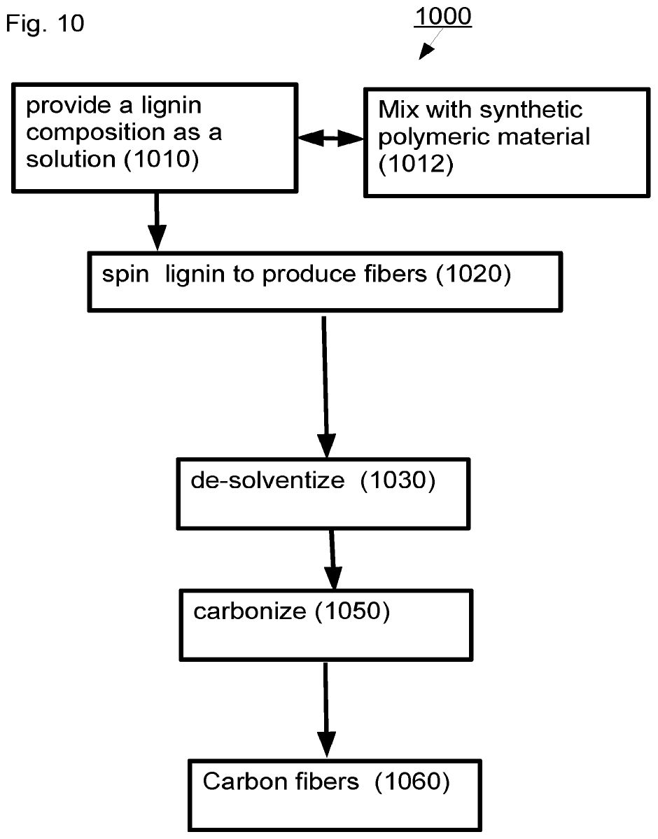

FIG. 10 is a simplified flow diagram of a spinning method according to some exemplary embodiments of the invention indicated generally as 1000. Depicted exemplary method 1000 includes providing 1010 a lignin composition as a solution, spinning 1020 to produce fibers of lignin and de-solventizing 1030 the fibers. In some embodiments, de-solventizing 1030 is performed as the fibers are formed.

In some exemplary embodiments of the invention, method 1000 includes mixing 1012 the lignin composition with a synthetic polymeric material. According to various exemplary embodiments of the invention the synthetic polymeric material includes polyacrylonitrile (PAN) and/or polypropylene and/or ABS and/or mylon. In some exemplary embodiments of the invention, a ratio of lignin:synthetic polymer (e.g. PAN) is ≥1:10; ≥1.5:10; ≥2:10; ≥2.5:10; ≥3:10 or; ≥3.5:10. Alternatively or additionally, in some embodiments a ratio of lignin:synthetic polymer (e.g. PAN) is ≤10:1; ≤9:1; ≤9:1; ≤5:1; ≤6:1; ≤50:1.

In some exemplary embodiments of the invention, methods 800, 900 and 1000 end with production of lignin fibers as described above. In other exemplary embodiments of the invention, methods 800, 900 and 1000 transform the lignin fibers to carbon fibers (860, 960 and 1060 respectively) by carbonizing (850, 950 and 1050 respectively) the lignin fibers. In some exemplary embodiments of the invention, carbonizing (850 and/or 950 and/or 1050) the lignin fibers is conducted concurrently on lignin and synthetic polymeric material (e.g. polyacrylonitrile). These embodiments produce carbon fibers which include a mixture of carbonized lignin and carbonized synthetic polymeric material.

### Exemplary Products Including Fibers According to Various Embodiments of the Invention

Lignin fibers and/or carbon fibers produced by any of methods 800, 900 and 1000 are exemplary embodiments of the invention. In some exemplary embodiments of the invention, these fibers are incorporated into products, and the resultant products are exemplary embodiments of the invention.

One example of such a product is a fabric. In some embodiments, fabrics according to exemplary embodiments of the invention are more flame retardant than similar fabrics not including fibers according to an exemplary embodiment of the invention.

Another example of such a product is an insulation material into which these fibers are incorporated. In some embodiments, such insulation materials are more flame retardant than similar insulation materials not including fibers according to an exemplary embodiment of the invention.

In some exemplary embodiments of the invention, lignin fibers and/or carbon fibers as described herein are incorporated into a composite material comprising a polymer. Exemplary polymers suitable for use in such a composite include, but are not limited to, epoxy, polyester, vinyl ester and nylon reinforced. Optionally, with fibers according to various exemplary embodiments of the invention contribute to strength of the composite. Optionally, this contribution is to a greater degree of strength than similar composites made with fibers from other sources. Such composites are useful, for example in preparation of plates or rods. Such plates or rods may be used, for example in preparation of sports equipment, automotive parts (e.g. fenders or doors), airplane or helicopter parts (e.g. rotor components and/or structural components), boat hulls or portions thereof and loudspeakers.

Exemplary Incorporation of Lignin into Polymers

In some exemplary embodiments of the invention, lignin according to one or more embodiments described herein is compounded with a polymer. Polymers suitable for use in such compounding include, but are not limited to polypropylene (PP) and poly-acrylonitrile butadiene styrene (ABS).

In some embodiments, the lignin compounded with the polymer at least partially spares a need for MgOH. Alternatively or additionally, in some embodiments, lignin serves as a charring agent in the compound and/or as a reinforcement agent and/or as a nucleation agent for the polymer. Use of lignin as a nucleation agent is expected to find utility, for example, in the injection molding industry as it contributes to ease of release of parts from a mold.

Exemplary Features of Products Produced from Lignin According to Exemplary Embodiments of the Invention

In those embodiments of the invention which relate to products produced from lignin, small but detectable amounts of marker molecules can serve to establish the source of the lignin from which the product was prepared. In this context “small but detectable amounts” indicates 1 PPB, 10 PPB or even 100PPB. Marker molecules which establish a link to lignin according to an embodiment of the invention as an input material include, but are not limited to S1 solvents (e.g. hexanol and/or 2-ethyl-1-hexanol), chlorides derived from S1 solvents (e.g. hexyl chloride), covalently bound chorine, and a lignin polymer bound to an alcohol of at least 6 carbon atoms by an ether bond.

### Exemplary Lignin Conversion Method

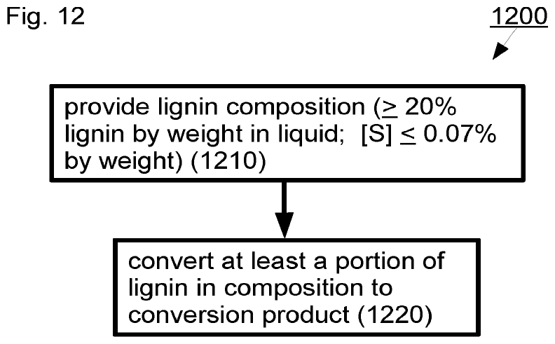

FIG. 12 is a simplified flow diagram of a method for converting lignin to a conversion product according to some exemplary embodiments of the invention indicated generally as method 1200.

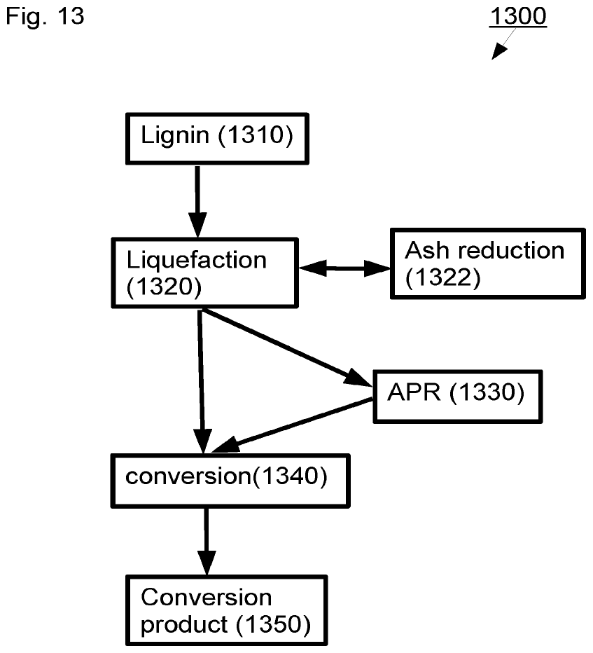

FIG. 13 is a schematic representation of a lignin conversion system according to some exemplary embodiments of the invention indicated generally as 1300.

The following description will refer to FIGS. 12 and 13. Reference numerals beginning with a 12 refer to FIG. 12. Those beginning with a 13, refer to FIG. 13.

Depicted exemplary method 1200 includes providing 1210 a lignin composition as described herein and converting 1220 at least a portion of lignin in the composition to a conversion product. In some embodiments, converting 1220 includes treating the lignin with hydrogen (e.g. in a hydrogenolysis reaction). In some exemplary embodiments of the invention, hydrogen is also produced from lignin.

According to various exemplary embodiments of the invention providing a composition may include one or more preparative processes as described herein below in the context of preparatory methods. These preparatory processes may include, but are not limited to, reduction of ash content 1322 in lignin 1310, treatment with hydrogen (e.g. hydrogenolysis and/or hydrogenation), pyrolysis and liquefaction 1320. In some embodiments, liquefaction includes dissolution in an organic solvent and/or dissolution in an alkaline solution.

According to various exemplary embodiments of the invention conversion product 1350 includes one or more, two or more, three or more, or four or more of the following: bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, phenols, toluenes, and xylenes.

In some exemplary embodiments of the invention, conversion product 1350 includes a fuel or a fuel ingredient. This fuel can be gasoline and/or kerosene and/or jet fuel and/or diesel fuel.

In some exemplary embodiments of the invention, conversion product 1350 includes para-xylene.

In some exemplary embodiments of the invention, converting 1220 or 1340 of lignin 1310 includes aqueous phase reforming (APR) 1330. Optionally, lignin 1310 is liquefied 1320 prior to APR 1330.

According to various exemplary embodiments of the invention converting 1220 and/or 1340 includes catalytic hydrotreating and/or catalytic condensation.

Alternatively or additionally, according to various exemplary embodiments of the invention converting 1220 and/or 1340 includes acid condensation and/or base catalyzed condensation and/or hydrogenation, dehydration, alkene oligomerization and alkylation (alkene saturation). According to some exemplary embodiments, acid condensation is catalyzed by a zeolite catalyst, e.g. ZSM-5. These processes are described in the context of sugar processing in a white paper entitled “Conventional liquid fuels from sugars” by P. G. Bommel and R. D. Cortright (Aug. 25, 2008) who exemplify the level of ordinary skill in the art.

In some embodiments, converting 1220 and/or 1340 occurs in at least two stages.

In some exemplary embodiments of the invention, a first stage includes APR 1330. Alternatively or additionally, in some embodiments, a second stage includes at least one of catalytic hydrotreating and catalytic condensation.

In some embodiments, method 1200 has a hydrogen consumption of less than 0.07 ton hydrogen per ton of product 1220. According to various exemplary embodiments of the invention this ratio is 0.06, 0.05 or even 0.04 or intermediate or lower values.

### Additional Exemplary Lignin Conversion Method

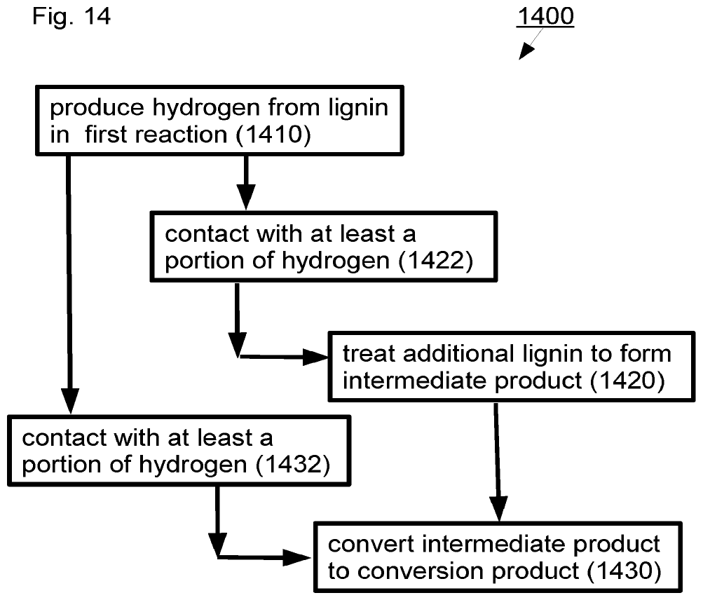

FIG. 14 is a simplified flow diagram of a method for converting lignin to a conversion product using hydrogen produced from lignin according to some exemplary embodiments of the invention indicated generally as method 1400.

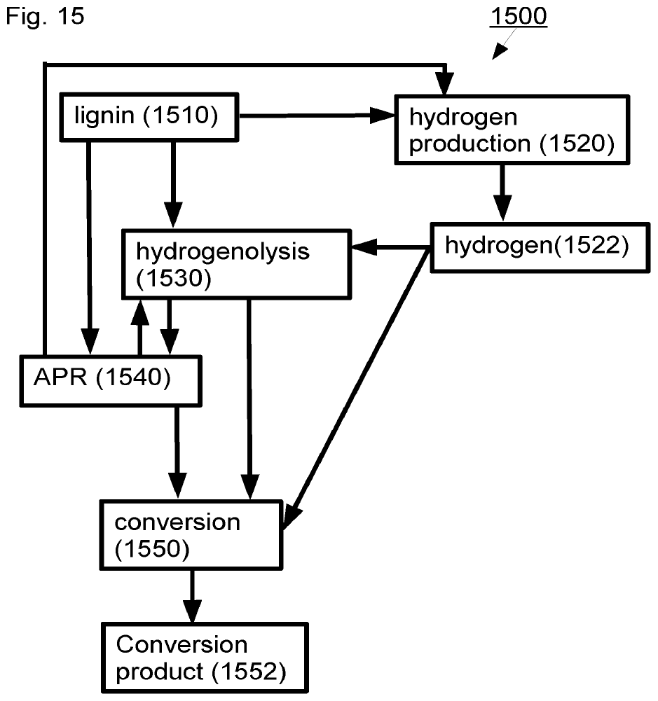

FIG. 15 is a schematic representation of a lignin conversion system which uses hydrogen produced from lignin according to some exemplary embodiments of the invention indicated generally as 1500.

The following description will refer to FIGS. 14 and 15. Reference numerals beginning with a 14 refer to FIG. 14. Those beginning with a 15, refer to FIG. 15.

Depicted exemplary method 1400 includes producing 1410 hydrogen from lignin in a first reaction.

Depicted exemplary method 1400 includes, treating 1420 additional lignin to form an intermediate product and converting 1430 the intermediate product to a conversion product.

According to depicted exemplary method 1400 treating 1420 and converting 1430 includes contacting 1422 and/or 1432 with at least a portion of the hydrogen produced at 1410. In some exemplary embodiments of the invention, this hydrogen is used for contacting in both treating 1420 and converting 1430

According to various exemplary embodiments of the invention the lignin (at 1410) and/or the additional lignin (at 1420) may each independently be produced, for example, by hydrolysis, by Kraft pulping or by an organosolve process.

In some embodiments, a lignin composition as described in the context of 1210 is used at 1410 and/or 1420. Optionally, this contributes to a simplification of the process in terms of chemistry and/or contributes to a reduction in process cost.

In those embodiments where lignin treated (1420) includes too much ash, treating 1420 may include reducing an amount of ash in the intermediate product.

In some embodiments, ion exchange methods are used to remove ash. Optionally, a reduction in an amount of ash may contribute to a reduction in fouling and/or poisoning of catalysts used in the converting of the intermediate product.

In those embodiments which employ exemplary lignin compositions as described herein, less reducing of ash, or none at all, may be required. In some embodiments, the intermediate product is liquid. Optionally, a liquid stream contributes to ease of ash removal.

In some embodiments, the first reaction (1410) includes aqueous phase reforming (APR) and/or pyrolysis and/or gasification.

In some embodiments, the intermediate product includes a liquid including at least 20% lignin by weight and having a sulfur concentration of less than 0.07% by weight as described in greater detail herein.

In some embodiments, treating 1420 includes one or more of hydrogenolysis hydrogenation, pyrolysis, dissolution in an organic solvent and dissolution in an alkaline solution. These reactions can contribute to liquefaction and/or depolymerization of lignin.

In some embodiments, converting 1430 occurs in at least two stages. Optionally, a first stage includes aqueous phase reforming (APR). Alternatively or additionally, a second stage includes catalytic hydrotreating and/or catalytic condensation.

In some embodiments, converting includes APR. Alternatively or additionally, in some embodiments converting 1430 includes acid condensation (e.g. with a zeolite catalyst such as ZSM-5) acid condensation and/or base catalyzed condensation and/or hydrogenation and/or dehydration and/or alkene oligomerization and/or alkylation (alkene saturation). In some embodiments, method 1400 includes consuming a portion of the hydrogen during converting 1430. Optionally, this is an additional portion of hydrogen.

In some embodiments, method 1400 has a hydrogen consumption of less than 0.07 ton per ton of product. According to various exemplary embodiments of the invention this value is 0.06, 0.05 or 0.04 or intermediate or lower values.

In some embodiments, converting 1430 yields a product having an O/C ratio <1.0 with carbon yield of at least 70%. According to various exemplary embodiments of the invention this carbon yield is 80, 90, 95 or 98% or intermediate or higher percentages.

In some embodiments, converting 1430 yields a product having an O/C ratio <0.1 with carbon yield of at least 70%. According to various exemplary embodiments of the invention this carbon yield is at least 50, 55, 60, 70 80, 90, 95 or 98% or intermediate or higher percentages.

In some embodiments, converting 1430 yields a product having an O/C ratio <1.0 with weight yield of at least 50%. According to various exemplary embodiments of the invention this weight yield is 55, 60, 65 or 70% or intermediate or higher percentages.

In some embodiments, converting 1430 yields a product having an O/C ratio <0.1 with weight yield of at least 50%. According to various exemplary embodiments of the invention this weight yield is 55, 60, 65 or 70% or intermediate or higher percentages.

Referring now to FIG. 15: depicted exemplary system 1500 employs lignin 1510 which may include Kraft lignin and/or organosolve lignin and/or lignin produced by any hydrolytic method and/or an exemplary lignin composition as described herein.

Depicted exemplary system 1500 sends a portion of lignin 1510 to a hydrogen production module 1520 which produces hydrogen 1522. Hydrogen production module 1520 may rely upon pyrolysis and/or gasification and/or APR 1540 of lignin 1510 to produce hydrogen 1522.

In parallel, system 1500 sends a portion of lignin 1510 (this may be a same lignin type or a different lignin type) to a conversion module 1550. Conversion module 1550 performs one or more chemical conversions as described herein in the context of 1220 and/or 1340. Optionally, conversion module 1550 consumes a portion of hydrogen 1522.

In some embodiments, the portion of lignin 1510 sent to conversion module 1550 passes through an APR module 1540 and/or a liquefaction module (depicted here as hydrogenolysis module 1530). In those embodiments which use hydrogenolysis, additional hydrogen 1522 is consumed.

Optionally, material produced by hydrogenolysis module 1530 is subjected to APR in APR module 1540 prior to conversion 1550 to conversion product 1552.

The nature of conversion product 1552 can vary with the type of lignin 1510 employed and/or the type of conversion 1550 and/or the type of APR and/or the type of liquefaction.

### Exemplary Conversion Products and Consumer Products

Conversion products produced by methods and/or systems described herein (see 1220 and/or 1350 and/or 1430 and/or 1552) are additional embodiments of the invention. Consumer products produced from such conversion products are additional embodiments of the invention. Consumer products containing such conversion products as an ingredient or component are additional embodiments of the invention.

In some embodiments, the product is having at least one of: (i) a sulfur concentration of less than 0.07% by weight, (ii) soluble sugar content of less than 1 by weight, (iii) a phosphorus concentration of less than 100 PPM; (iv) total ash content of less than 0.5% wt; and (v) total tall oils content of less than 0.5%.

In some embodiments, the consumer or conversion product includes at least one, two, three or four chemicals selected from the group consisting of lignosulfonates, bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene and pharmaceuticals.

In some embodiments, the consumer or conversion product includes para-xylene.

In some embodiments, the consumer or conversion product is selected from the group consisting of dispersants, emulsifiers, complexants, flocculants, agglomerants, pelletizing additives, resins, carbon fibers, active carbon, antioxidants, liquid fuel, aromatic chemicals, vanillin, adhesives, binders, absorbents, toxin binders, foams, coatings, films, rubbers and elastomers, sequestrants, fuels, and expanders.

In some embodiments, the consumer or conversion product is used in an area selected from the group consisting of food, feed, materials, agriculture, transportation and construction.

In some embodiments, the consumer or conversion product has a ratio of carbon-14 to carbon-12 of about 2.0×10⁻¹³ or greater.

In some embodiments, the consumer or conversion product includes an ingredient produced from lignin and an ingredient produced from a raw material other than lignocellulosic material. Optionally, the ingredient produced from lignin and the ingredient produced from a raw material other than lignocellulosic material are essentially of the same chemical composition.

In some embodiments, the consumer or conversion product includes a marker molecule at a concentration of at least 100 ppb. According to various exemplary embodiments of the invention the marker molecule is selected from the group consisting of furfural and hydroxy-methyl furfural, products of their condensation, color compounds, acetic acid, methanol, galacturonic acid, glycerol, fatty acids and resin acids.

Exemplary Methods to Produce Liquid Compositions with Lignin

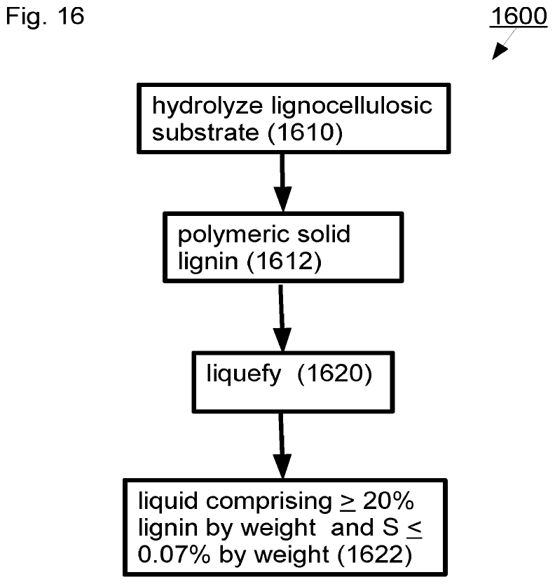

FIG. 16 is a simplified flow diagram of a method to produce a low sulfur liquid lignin composition (as described herein) according to some exemplary embodiments of the invention indicated generally as method 1600.

Depicted exemplary method 1600 includes hydrolyzing 1610 a lignocellulosic substrate to produce polymeric solid lignin 1612; and liquefying 1620 solid lignin 1612 to form a liquid 1622 including: at least 20% lignin by weight (on an as is basis) and has a sulfur concentration of less than 0.07% by weight (on a dry matter basis). In some embodiments, lignin 1612 may contain residual cellulose. Optionally, the amount of residual cellulose is 5, 10, 15, 20 or even 30% or more by weight.

As used in this specification and the accompanying claims the terms “liquefying” and/or “liquefaction” indicate any treatment converting a solid compound into a liquid composition.

In some embodiments, liquefying 1620 includes de-polymerizing polymeric lignin 1612. According to various exemplary embodiments of the invention this de-polymerization is partial or complete.

In some embodiments, liquefying includes contacting lignin 1612 with an alkaline solution

In some embodiments, liquefying includes contacting lignin 1612 with an organic solvent.

In some embodiments, liquefying 1620 includes pyrolysis of lignin 1612. In some embodiments, liquefying 1620 includes gasification of lignin 1612. In some embodiments, liquefying 1620 includes oxidation of lignin 1612. In some embodiments, liquefying 1620 includes reduction of lignin 1612. In some embodiments, liquefying 1620 includes base-catalyzed depolymerization of lignin 1612. In some embodiments, liquefying 1620 includes hydrolysis of lignin 1612. Optionally oxidation includes contacting with an oxidant such as hydrogen peroxide. In some cases this oxidation produces carboxylic acid moieties on the lignin. In some cases said oxidation forms said lignin composition at pH<10. In some cases said oxidation forms said lignin composition at pH >4.

Alternatively or additionally, if the carboxylic acid moiety is protonated, the lignin is soluble in an organic solvent without regard to pH.

In some embodiments, liquefying 1620 includes hydrogenolysis of lignin 1612.

In some embodiments, polymeric solid lignin 1612 is produced as an acidic stream and the method includes: contacting the stream with an S1 solvent to produce solvent containing lignin; dissolving the solvent containing lignin in a basic solution (pH>9); and separating the solvent from the basic solution. According to these embodiments, the lignin is in the solution at the end of this process. Suitable S1 solvents include, but are not limited to, hexanol, 2-ethyl 1 hexanol and solvent mixtures containing one or both of them.

In some embodiments, liquefying 1620 includes contacting solid lignin 1612 with both a basic solution and a solvent. In some embodiments, the solvent is an APR product as described herein. Alternatively or additionally, in some embodiments, solid lignin 1612 is first contacted with an alkali solution and then with a solvent. Optionally, this order of contacting contributes to an increase in concentration of lignin in the liquid.

In some embodiments, method 1600 includes contacting lignin 1612 with a basic solution (pH>9) at a temperature >120° C. According to various exemplary embodiments of the invention this contacting temperature is as high as 130, 140, or 150° C. or intermediate or greater temperatures. In some embodiments, the contacting with the solution occurs in a closed vessel and the solution is heated until the pressure is greater than 12, 14, 16, 18 or even 20 atmospheres or more. Optionally, this contacting contributes to liquefying 1620. Ammonia or an ammonium salt is used to achieve pH>9 in some embodiments. Alternatively or additionally, In some exemplary embodiments of the invention, employ a sodium base, e.g. sodium hydroxide, bicarbonate or carbonate is used to achieve pH>9. Alternatively or additionally, liquefying 1620 includes contacting with an organic solvent. According to various exemplary embodiments of the invention, the organic solvent may include one or more mono-, di- or tri-oxygenates including 2-6 carbons. Alternatively or additionally, the organic solvent is a product of an aqueous phase reforming reaction (APR).

In some exemplary embodiments of the invention, method 1600 includes performing APR on liquid 1622.

In some exemplary embodiments of the invention, liquefying 1620 includes removal of at least a portion of the ash from lignin 1612. For example an ion exchange method can be used to remove ash.

### Exemplary Integrated Processing

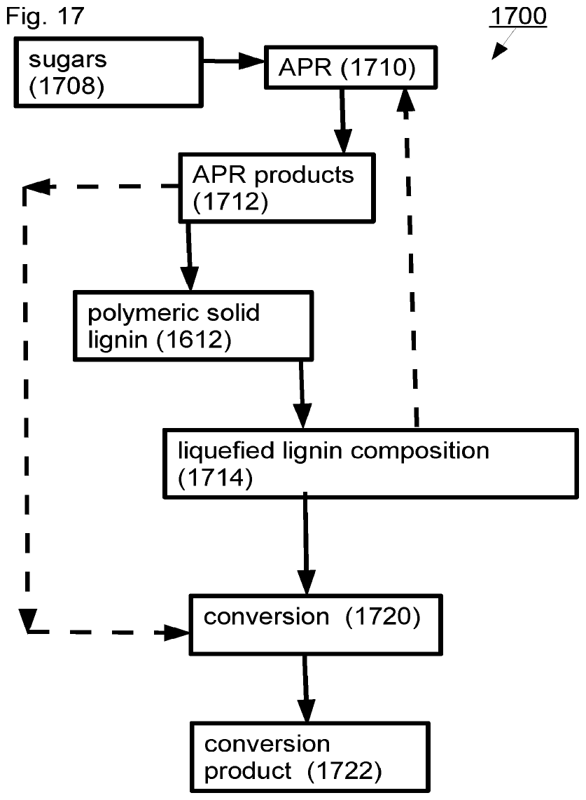

FIG. 17 is a schematic representation of an integrated sugar and lignin conversion system according to some exemplary embodiments of the invention indicated generally as 1700. Depicted exemplary system processes two carbon inputs concurrently. One carbon input is sugars 1708. These sugars may be, for example, from hydrolyzate 130. The second carbon input is polymeric solid lignin 1612.

In the depicted exemplary embodiment, APR module 1710 processes sugars 1708 to produce APR products 1712. APR products 1712 include one or more organic solvents. Contact of organic solvents from APR products 1712 with polymeric solid lignin 1612 (e.g. in a hydrogenolysis module) produces a liquefied lignin composition 1714.

In those embodiments where sugars 1708 and polymeric solid lignin 1612 both originate from a single hydrolysis reaction, there is likely to be an excess of sugars. In the depicted embodiment, a portion of APR products 1712 optionally proceed directly to conversion module 1720, without contacting polymeric solid lignin 1612.

Liquefied lignin composition 1714 proceeds to conversion module 1720 where it is converted to conversion product 1722. In some embodiments, conversion 1720 and/or hydrogenolysis consume hydrogen. Optionally, this hydrogen is produced from lignin as explained herein in the context of FIGS. 14 and 15.

### Exemplary Options

Referring again to FIG. 1: in some cases, substrate 112 is chipped wood. During the chipping process, some fine fragments are formed which are far smaller than the target chip size. In some embodiments, substrate 112 is sorted into chips and fine fragments (e.g. by sieving). The chips are loaded into vessel 110 and used to produce lignin 220. In some embodiments, the fine fragments are incorporated into the process.

According to various exemplary embodiments of the invention the fine fragments are combined with lignin 220 and/or used for hydrogen production 1510 and/or subject to hydrogenolysis and/or subject to APR.

In some exemplary embodiments of the invention, maintaining the ratio of fines: total substrate 112 below a certain threshold (e.g. ≤10%) contributes to a reduction in efficiency of contact between substrate 112 and acid 140 in reactor 110. This reduction in efficiency manifests as an increase in residence time. In creased residence time can contribute in turn to increased capital costs and/or higher levels of degradation products in hydrolyzate 130. Using the fines as described here contributes to a reduction in magnitude of the reduction in efficiency of contact caused by the fines with all that entails.

Alternatively or additionally, in some embodiments substrate 112 is pre-extracted with an organic solvent (e.g. acetone) and/or a weak acid (e.g. sulfurous acid and/or acetic acid) to separate pitch and/or tall oils. Exemplary pre-treatments for substrate 112 which can separate pitch and/or tall oils are described in co-pending application PCT/US2011/064237; which is fully incorporated herein by reference.

According to various exemplary embodiments of the invention the pitch and/or tall oils are combined with lignin 220 and/or used for hydrogen production 1510 and/or subject to hydrogenolysis and/or subject to APR.

The description above has focused in lignin 220 for clarity and brevity. However, in some embodiments, sugars from hydrolyzate 130 also play a role.

For example, sugars from hydrolyzate 130 can be combined with lignin 220 and/or subject to hydrogenolysis and/or subject to APR and/or subject to conversion.

Alternatively or additionally, sugars from hydrolyzate 130 are fermented and non-fermented sugars are recovered from the fermentation broth. These non-fermented sugars can be combined with lignin 220 and/or subject to hydrogenolysis and/or subject to APR and/or subject to conversion.

Alternatively or additionally, in some embodiments sugar degradation products (e.g. furfurals) are recovered from hydrolyzate 130 and/or lignin stream 120. Optionally, these sugar degradation products are combined with lignin 220 and/or subject to hydrogenolysis and/or subject to APR and/or subject to conversion and/or used to produce hydrogen.

### Exemplary Lignin Purification System

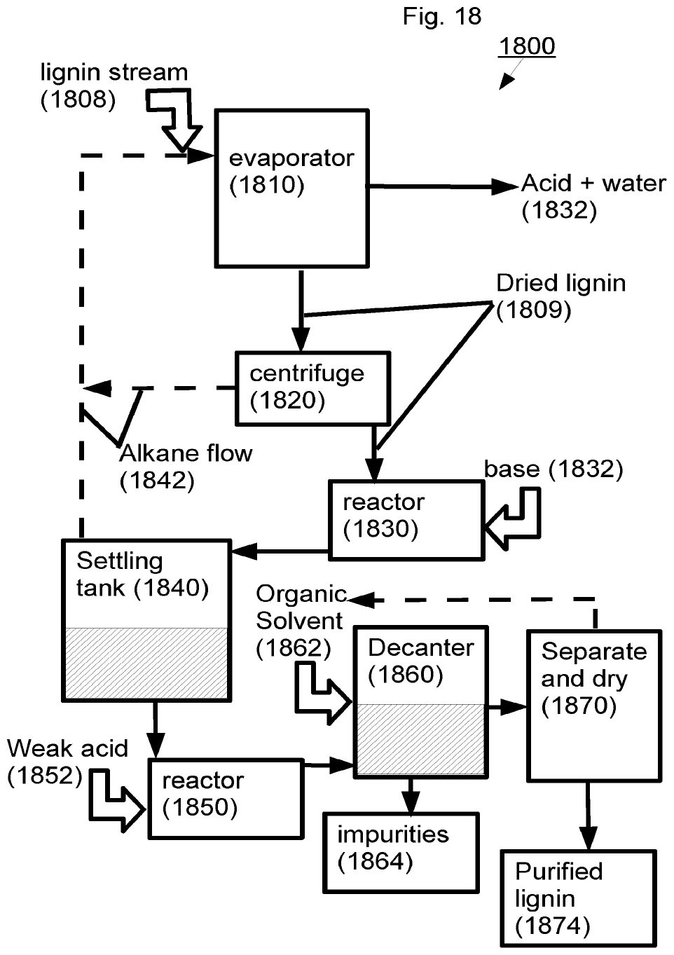

FIG. 18 is a schematic representation of lignin purification system according to some exemplary embodiments of the invention indicated generally as 1800. Depicted exemplary system 1800 includes an evaporator 1810. In some embodiments, evaporator 1810 is a Calandria evaporator (Swenson Technology Inc.; Monee IL; USA). In the depicted exemplary embodiment, evaporator 1810 receives a lignin stream 1808 mixed with an alkane flow 1842. In some embodiments, the alkane is dodecane. In some embodiments, alkane flow 1842 displaces acid and/or water 1832 from lignin stream 1808 and dried lignin 1809 exits evaporator 1810. In the depicted exemplary embodiment, a centrifuge 1820 recovers some alkane 1842 from dried lignin 1809 and recycles the alkane. Dried lignin 1809 proceeds to a reactor 1830 where it contacts base 1832. Base 1832 may include, for example, a hydroxide (e.g. NaOH or KOH) or ammonia or a carbonate salt (e.g. Na₂CO₃). In some embodiments, contact with base 1832 dissolves dried lignin 1809.

In the depicted exemplary embodiment, contents of reactor 1830 are transferred to a settling tank 1840 where the alkane phase floats over an aqueous phase containing dissolved lignin.

Alternatively or additionally, in some embodiments the dissolved lignin is transferred to an additional reactor 1850 where it is contacted with a weak acid 1852. In some embodiments, sufficient weak acid 1852 is added to lower the pH to ≤4. According to various exemplary embodiments of the invention weak acid 1852 includes acetic acid and/or carbonic acid. Optionally, carbonic acid is provided as CO₂ gas under pressure. In some embodiments, contact with weak acid 1852 causes at least a portion of the lignin to re-solidify.

In the depicted exemplary embodiment, contents of reactor 1850 are transferred to an extractor 1860 where they are contacted with extractant comprising an organic solvent 1862. In some embodiments, organic solvent 1862 includes ethyl acetate. In some exemplary embodiments of the invention, the lignin migrates to the organic phase. In some embodiments, this migration contributes to purity of the lignin. In some embodiments, contacting with the weak acid and contacting with an extractant are conducted in the same vessel and/or concurrently.

In the depicted exemplary embodiment, in a decanter 1860 the organic phase containing lignin is separated from an aqueous phase containing impurities 1864.

In the depicted exemplary embodiment, the organic phase from decanter 1860 is subjected to separation and drying 1870 to produce purified lignin 1874.

In various exemplary embodiments of the invention, separation and drying 1870 includes centrifugation and/or spray drying and/or drying with a Rosinaire™ dryer (Barr-Rosin; UK). Alternatively or additionally, in some embodiments, purified lignin 1874 is includes less than 3%, optionally less than 1%, non-lignin material and/or has an ash content of less than 0.1% and/or has a total carbohydrate content of less than 0.05% and/or has a non melting particulate content (>1 micron diameter) of less than 0.05% and/or a volatiles content of less than 5% at 200° C. Particles with a diameter less than 1 micron are not considered when calculating the percentage. “Non-melting” here indicates does not melt at 150° C. In some embodiments, the >1 micron diameter particulate content melts at a temperature ≥175; ≥200; ≥225 or ≥250° C.

### Exemplary Lignin Purification Method

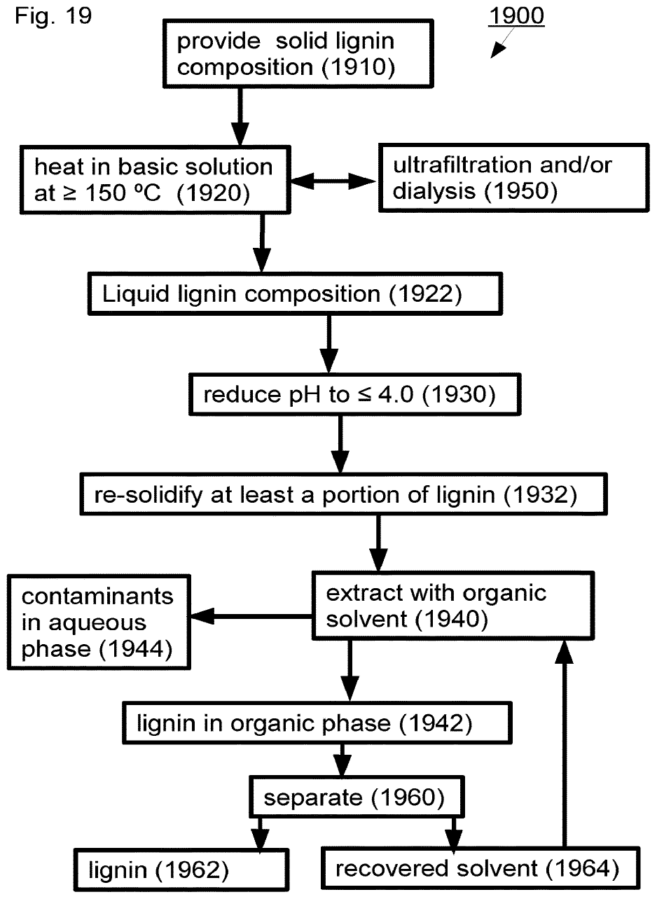

FIG. 19 is a schematic representation of lignin purification method according to some exemplary embodiments of the invention indicated generally as 1900. Depicted exemplary system 1900 includes providing 1910 a composition comprising de-acidified solid lignin. In some exemplary embodiments of the invention, providing includes washing of a lignin stream to remove sugars resulting from acid hydrolysis and/or to reduce an amount of acid associated with the lignin. Exemplary methods and equipment to remove sugars resulting from acid hydrolysis and/or to reduce an amount of acid associated with the lignin are described in co-pending application PCT/IL2011/000424; which is fully incorporated herein by reference. In the depicted exemplary embodiment, method 1900 includes heating 1920 the composition in a basic solution at a temperature ≥150° C. to produce a liquid lignin composition 1922 as described herein.

According to various exemplary embodiments of the invention the basic solution at 1920 includes NaOH and/or ammonia. In some exemplary embodiments of the invention, a solution of 3 to 6% NaOH is employed at 1920. Optionally, the basic solution at 1920 includes anthraquinone and/or peroxide.

Depicted exemplary method 1900 includes reducing 1930 a pH of the solution to ≤4.0 to re-solidify at least a portion of the lignin and extracting 1940 the solution with an organic solvent. In some embodiments, lignin migrates to the organic phase and contaminants remain in the aqueous phase. According to various exemplary embodiments of the invention the lignin remains solid or re-dissolves in the organic phase.

In some embodiments, method 1900 includes performing 1950 ultrafiltration and/or dialysis of the basic solution after heating 1920.

Depicted exemplary method 1900 includes separating 1960 the lignin from the organic solvent. According to various exemplary embodiments of the invention this separation is by drying (as explained above in the context of FIG. 18) and/or by spinning (e.g. wet spinning). Lignin 1962 recovered by separation 1960 has a high degree of purity (see description of purified lignin 1874; FIG. 18; herein).

In some embodiments, separation 1960 produces recovered solvent 1964. In the depicted exemplary embodiment, recovered solvent 1964 is recycled to extraction 1940.

### Exemplary Specific Gravity Considerations

Lignin according to various embodiments of the invention described herein has a specific gravity of about 1.3. This is relatively high compared to synthetic polymers (e.g. the specific gravity of polypropylene is about 0.9). However, many industrially acceptable fillers have a specific gravity much higher than that of lignin (e.g. calcium carbonated has a specific gravity of 2.5). Alternatively or additionally, flame retardants compounded with synthetic polymers are often characterized by a high specific gravity (e.g. MgOH has a specific gravity of 4). This means that in many embodiments of the invention, use of lignin in place of a conventional filler or flame retardant actually contributes to a reduction in specific gravity of a composition including a synthetic polymer.

### Exemplary Environmental Impact Considerations

In some exemplary embodiments of the invention, lignin is used to replace a portion of the synthetic polymer when compounding a plastic. Many synthetic polymers are derived from petrochemicals, while lignin is typically derived from plant matter such as wood. Therefore, use of lignin according to various exemplary embodiments of the invention as a filler in plastics contributes to a reduction in carbon footprint of the resultant plastic, relative to a similar plastic compounded without lignin.

It is expected that during the life of this patent many hydrolytic processes for cellulose will be developed and the scope of the invention is intended to include all such new technologies a priori.

As used herein the term “about” refers to ±10%; ±5%; ±1%; ±0.5% or ±0.01%.

Although the invention has been described in conjunction with specific embodiments thereof, it is evident that many alternatives, modifications and variations will be apparent to those skilled in the art. Accordingly, it is intended to embrace all such alternatives, modifications and variations that fall within scope of the appended claims.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus or system and features used to describe an apparatus or system can be used to characterize a method.

Alternatively, or additionally, features used to describe an apparatus can be used to characterize a system and features used to describe system can be used to characterize an apparatus.

It should be further understood that the individual features described herein can be combined in all possible combinations and sub-combinations to produce additional embodiments of the invention. The examples given above are exemplary in nature and do not limit the scope of the invention which is defined solely by the following claims. Specifically, the invention has been described in the context of methods but might also be give rise to apparatus and/or systems with similar features.

Each recitation of an embodiment of the invention that includes a specific feature, part, component, module or process is an explicit statement that additional embodiments not including the recited feature, part, component, module or process exist.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated herein and as claimed in the claims section below finds experimental support in the following examples.

### EXAMPLES

Reference is now made to the following examples, which together with the above descriptions; illustrate the invention in a non-limiting fashion.

The following materials and methods are used in performance of experiments described in examples herein:

Lignin:

Unless otherwise indicated, reference to “Residual Lignin” in these examples indicates material as received from a pilot scale operation using pinewood as a hydrolysis substrate and hydrolyzed substantially as described in U.S. 61/483,777 and treating the un-hydrolyzed lignin substantially as described in PCT/IL2011/000424.

Each of these co-pending patent applications is fully incorporated herein by reference. This lignin includes about 25% unhydrolyzed cellulose on a dry matter basis. In some cases, lignin was subject to additional treatment to remove residual cellulose:

“HCl Lignin” indicates lignin with substantially no cellulose as formed on nearly full hydrolysis of cellulose by HCl according to U.S. 61/483,777. For the purpose of the examples here, Residual Lignin was subjected to further hydrolysis in 42% HCl (1:10 lignin-to-acid) for 24 hours at 13° C., filtered, washed thoroughly with water, and oven dried at 100° C.;

“Klason Lignin” as used in these examples indicates Residual Lignin subjected to further hydrolysis in 72% H₂SO₄ for 1 h, diluted to 3% sulfuric acid with water and incubated at 121° C. for 1 h, filtered, washed thoroughly with water, and dried as for HCl lignin. It is important to note that, “Klason Lignin” refers to lignin formed by hydrolyzing the vast majority of the cellulose by HCl, followed by hydrolyzing the rest by sulfuric acid. It is believed that this lignin is markedly different from “Standard Klason Lignin” where the majority or all the cellulose is hydrolyzed with sulfuric acid.

“Enzyme Treated Lignin” indicates Residual Lignin that was washed with water and dried in the oven at 105° C. overnight. For incubation 10 volumes of water were added to a weighed sample and the pH adjusted to 4.8 using 0.1N NaOH. One sample was taken as control and included only water and dry lignin (adjusted to pH 4.8 as well). Three enzymes were added to the tube containing the actual enzyme treated sample: Accelerase Duet, Accelerase Bg and Spirizyme Fuel HS. Spirizyme fuel: 67 mg enzyme to 1 g (100%) sugar, Accelerase duet: 80 mg/l g sugar, Accelerase Bg: 80 mg/l g sugar. The tubes were placed in the shaker at 60° C., 200 rpm for 3 days. Then a sample was taken from the aqueous phase, the solid was filtered and washed with water, then placed in the oven to dry overnight.

“Kraft lignin” was purchased from Sigma Aldrich (St. Louis Mo., USA) and served as a control.

Size Fractionation:

1360.2 g of dried lignin was partially sieved on “Vibratory sieve shaker AS 200 digit” (Retsch Inc.; Newtown, Pa., USA) with mesh sizes as indicated in Table 1. Every portion of lignin was separated under amplitude of 50 and for 5 min. Each fraction was weighed and distribution was evaluated according the following sieves dimensions.

TABLE 1
Mesh sizes for size fractionation of lignin:

| Mesh No | Aperture (μm) |
|---|---|
| 8 | 2360 |
| 30 | 600 |
| 40 | 425 |
| 80 | 180 |
| 140 | 106 |
| 200 | 75 |

### ICP and Ash Analysis:

Samples of lignin were digested in acid solutions (hydrochloric and nitric acids) at 95° C. for approximately 1 h and analyzed by Perkin Elmer (Waltham Mass., USA) model 4300DV ICP-OES instrument according to EPA 6010B metals in water and waste water procedures. Additional standards at different concentrations were spiked in sample and blank.

### CP/MAS ¹³C NMR—

¹³C spectra were acquired on Bruker Avance III 500 MHz spectrometer (Bruker BioSpin Corp., Billerica, Mass., USA) using a 4 mm VTN CPMAS HX probe, using MAS at 8 kHz. Cross-polarization (CP) experiments were carried out using a typical ramped pulse on the protons and a square pulse on ¹³C. The CP contact time was 1.4 milliseconds.

### TGA/DTG—

Thermo gravimetric analysis (TGA) and differential thermal analysis (DTA) of lignin were performed using a simultaneous thermal analyzer Q50 (TA Instruments, USA). The sample was heated from 30 to 950° C. at a rate of 10° C./min with a N₂ flow of 55 ml/min.

### DSC—

DSC measurements were carried out on DSC Q100 (TA Instruments, USA) over the 30-550° C. temperature range, at a heating rate of 10° C./min with N₂ flow of 50 ml/min.

### Electron Microscopy—

Scanning electron micrographs (SEM) of structure and surface were carried out on different samples of lignin <200 mesh. The powder samples were mounted on specimen stubs and coated with gold under vacuum of 100 miliTorr at RT. All photographs were taken at 3 to 5 kV accelerating voltage by using a field emission scanning electron microscope, FEI Inspect S (Oregon, USA).

### Elemental Analysis & Density—

Bulk density was performed according to ASTM-B527-93 (2000) which is standard test for determination of Tap density. The Elemental analysis of carbon, nitrogen, hydrogen and sulfur content of organic material is determined by the FLASH EA 111 CHNS Analyzer. Samples were incinerated under 900° C. using He and 02 atmosphere with flow rates of 140 ml/min and 250 ml/min respectively.

### Solubility—

Approximately 5 g of the sieved lignin (8<mesh<30) was blended with 120-150 g of various solvents according to the Table below. A high shear mixer, Silverson L4RT (Silverson, USA) equipped with square hole high shear screen and round emulsion screen was adjusted to 6000 rpm speed. The mixtures were stirred for 1 to 2 hours (see below) at RT and filtered under reduced pressure. The wet lignin was washed with ethanol and was evaporated to dryness. In order to identify small phenols, the solution was filtered through 0.22 μm and tested on HPLC-UV (k=280 nm).

TABLE 2
Lignin solubility measurement parameters

| Sample | Lignin | | Solvent | Mixing |
|---|---|---|---|---|
| No | weight (g) | Solvent Type | weight (g) | time (min) |
| 1 | 5 | DMF | 144 | 105 |
| 2 | 5 | 2-(2-ethoxyethoxy) | 150.4 | 60 |
| | | ethylacetate | | |
| 3 | 5.1 | DMSO | 150.4 | 105 |

### Example 1

### Particle Size Distribution

In order to determine the particle size distribution, Residual Lignin was sieved as described above.

Particle size distribution is summarized in Table 3.

TABLE 3
Residual Lignin particle size distribution

| size (μm) | % of total weight |
|---|---|
| >2360 | 0.1 |
| 600-2360 | 38.16 |
| 425-600 | 17.64 |
| 180-425 | 27.47 |
| 106-180 | 7.05 |
| 75-106 | 2.37 |
| <75 | 7.67 |

### Example 2

### ICP and Ash Analysis

Residual Lignin was incinerated and the remaining ash fraction (ash content) was 0.38% on a dry matter basis.

Inductively coupled plasma (ICP) analysis indicated the presence of specific minerals in quantities as summarized in Table 4.

TABLE 4
Quantitative mineral content in Lignin

| Element | (mg/kg) dry matter |
|---|---|
| Al | 139.7 |
| Ca | 1233.7 |
| Fe | 176 |
| K | 44.2 |
| Mg | 112.4 |
| Na | 202 |
| S | 279 |
| Si | 91 |
| Zn | 53 |
| P | <1.0 |

### Example 3

### Elemental Analysis and Density

Quantities of carbon and hydrogen in lignin according to exemplary embodiments of the invention were measured and oxygen amount was calculated by difference. Results are summarized in Table 5.

TABLE 5a
Elemental analysis of lignin

| | Elements | Residual Lignin | HCL Lignin |
|---|---|---|---|
| Elemental | C (%) | 57.5 | 63.2 |
| Analysis | H (%) | 6.32 | 6.09 |
| | O (%) | 36.08 | 29.89 |
| Formula | | C₉H_{11.78}O_{4.24} | C₉H_{10.42}O_{3.2} |
| Total Chlorine | Cl (%) | 0.46 | 0.93 |

Results presented in Table 5a indicate a relatively low O to C ratio in the assayed lignin. Since the Residual Lignin includes roughly 25% cellulose, HCl lignin has an even lower ratio.

Table 5b summarizes C/O ratios in lignin samples according to various exemplary embodiments of the invention with different amounts of residual cellulose as well as lignin from other sources. Results summarized in Table 5b suggest that lignin described herein is characterized by a lower C/O ratio than previously available Kraft Lignin or Sulfite Lignin. Once cellulose is removed (see HCl lignin), the C:O ratio is reduced even further. It is believed that Klason lignin and enzymatically treated lignin will have relative oxygen levels similar to that of HCl lignin.

TABLE 5b
Lignin Formula in samples from various sources

| Sample | Formula | Type |
|---|---|---|
| Residual lignin | C9H11.78O4.24 | embodiment |
| (approximately | | |
| 25% cellulose) | | |
| Lignin | C9H11.25O3.68 | By calculation* |
| (approximately | | |
| 18.75% | | |
| cellulose) | | |
| Lignin | C9H10.72O3.11 | By calculation |
| (approximately | | |
| 12.5% | | |
| cellulose) | | |
| Lignin | C9H10.18O2.55 | By calculation |
| (approximately | | |
| 6.25% | | |
| cellulose) | | |
| HCl lignin | C9H9.65O1.98 | Calculated |
| (presumed | | based upon |
| cellulose free) | | Residual lignin |
| | | value |
| Kraft lignin | C9H7.63O6.63 | Basis for |
| | | comparison |
| Organosolv | C9H8.64O2.84 | Basis for |
| lignin | | comparison |
| Sulfite lignin | C9H11.83O7.56 | Basis for |
| | | comparison |

*Using residual lignin with 25% cellulose as a base and a calculated value for HCl lignin presumed cellulose free. Cellulose is presumed to have a formula of (C₆H₁₀O₅)ₙ for purposes of calculation.

Results of density and bulk density measurements of Residual Lignin are summarized in Table 6. Results summarized in Table 6 suggest a relatively high degree of porosity and/or inter-particulate spacing.

TABLE 6
Density measurements of lignin

| | | Lignin |
|---|---|---|
| Bulk density | Primary density | 0.42 |
| (g/ml) | Final density | 0.52 |
| | Average density | 0.47 |
| Density | | 1.28 |
| (g/ml) | | |

### Example 4

### CP/MAS ¹³C NMR Analysis

Residual Lignin was assayed by NMR to determine how it differs from pine wood and/or cellulose.

The results indicate that the assayed lignin contains both crystalline and amorphous forms of cellulose. The observed peaks resemble those observed in a similar analysis of pine wood on a qualitative basis. Analysis of fractions containing various particle sizes (see Table 3) produced similar results.

Similar NMR assays conducted on Klason lignin, HCl lignin and enzyme treated lignin indicated a significant decrease in the amount of cellulose associated with the lignin. These results are consistent with molecular formula analyses presented in Table 5b.

Some exemplary embodiments of the invention relate to an isolated lignin or lignin-containing composition with lignin containing less than 10% cellulose.

### Example 5

### TGA & DTG Analysis

Amorphous polymers such as lignin undergo a transition from a “glassy” state to a “rubbery” state at some temperature. This temperature is referred to as a glass transition temperature (Tg) and is often used to characterize a polymer.

The thermogravimetric behavior of isolated lignin samples is often difficult to determine. This difficulty is attributed to the source of lignin, heterogeneity of the chemistry within the lignin molecule (functional groups) and broad Mw distributions.

In some cases, interrupting inter- and intramolecular hydrogen bonding by chemical derivatization of hydroxyl groups within the lignin (e.g. by esterification or alkylation) can reduce the heterogeneity of the polymer molecule population and make the Tg more easily discernible. Often, this is accompanied by an increase in the solubility of the lignin and its ability to undergo melt flow.

In a conventional TGA curve for lignin, weight loss starts around 190° C. and continues to 600° C. However cellulose has narrow weight loss between 330 to 380° C. due to its crystalline structure. Therefore, cellulose in a lignin sample can cause an inflection point of the main degradation step, which appears as a peak in the first derivative (DTG) curve.

TABLE 7
DTG inflection peak temperature for various samples

| Sample | Temperature ° C. |
|---|---|
| Cellulose | 360 |
| Residual | 348 |
| Lignin < 200 mesh | |
| HCL lignin | 350 |
| Klason lignin | 393 |
| Enzyme lignin | 358 |
| Kraft lignin* | 355 |

*Sigma

Assayed lignin samples according to various exemplary embodiments of the invention (Residual; HCl; Klason; Enyzme) show a broad DTG curve with shoulder around 430° C.

### Example 6

### Additional TGA & DTG Analysis

TGA weight loss of lignin occurs in two stages: in the first stage there is water evaporation/dehydration and in the second stage thermal degradation takes place and divides to sub-steps.

Table 8 summarizes the onset of thermal degradation temperatures (Tᵢ), the temperature corresponding to maximum weight loss (Tₘₐₓ), mass loss (residual mass) of every decomposition sub-step (Δw_{d}) at a certain temperature, residual mass at ˜600° C. and total mass loss. All temperatures are in ° C.

TABLE 8
Thermal degradation of lignin

| | | | | | | Residual | Total |
|---|---|---|---|---|---|---|---|
| | | | | | | mass (%) | mass loss |
| Sample | Tᵢ | Tₘₐₓ | Δw_{d} (%) - \| | Δw_{d} (%) - \|\| | Δw_{d} (%) - \|\|\| | at ~600° C. | (%) |
| Cellulose | 334.7 | 360 | 90@360 | — | — | 10@400° C. | 90 |
| Lignin <200 | 280 | 348 | 37.96@348 | 20.8@430 | 10.99@585 | 30.25 | 69.75 |
| HCL Lignin | 245.5 | 350 | 21.83@350 | 13.4@422 | 15.45@580 | 49.32 | 50.68 |
| Klason | 188.5 | 393 | 25.35@393 | 9.5@430 | 16.43@600 | 48.73 | 51.27 |
| Lignin | | | | | | | |
| Enzyme | 268 | 358 | 25.26@358 | 16.87@429 | 13.96@598 | 43.81 | 56.19 |
| Lignin | | | | | | | |
| Sigma Kraft | 263 | 355 | 24.46@355 | — | — | 48.63 | 51.37 |
| Lignin | | | | | | | |

Results summarized in Table 8 indicate that about 20% of carbohydrate polymers remained in “Residual Lignin”. This is consistent with data from solid state NMR and HPLC assays which indicated 21 and 26% residual cellulose respectively.

The lignin <200 mesh size fraction, Klason lignin, HCl lignin and Enzymatic lignin each show a broad DTG curve with shoulder around 430° C., while pure cellulose shows a sharp peak at 360° C. Most of the assayed lignin samples decompose at 350° C.

### Example 7

### Differential Scanning Calorimetry

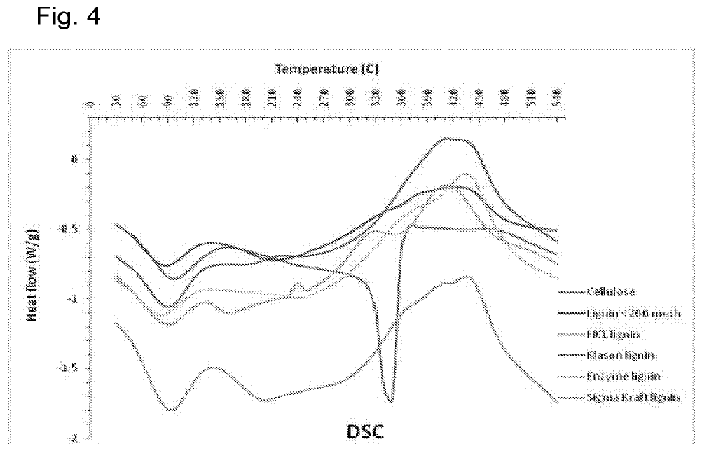

DSC patterns of Lignin samples according to various exemplary embodiments of the invention are shown in FIG. 4. The endotherms extended from about 100 to 250° C., are followed by an exotherm around 430° C. Similar data for cellulose and Kraft Lignin is provided for comparison.

The first endothermic reaction occurred around 100° C. and is believed to indicate the evaporation/dehydration of the absorbed water and the desorption of gases.

The second low and broad endotherm situated between 130 and 250° C. may represent cleavage of thermally unstable α- and β-aryl-alkyl-ether. Alternatively or additionally, this shallow and relatively flat portion of the curve may be related to the softening point of lignin but not to its melting point due to the absence of sharp endothermic peak as could be seen on cellulose thermograph.

After this decomposition, smaller non-volatilized molecules apparently re-combine to form char, causing the exothermic reaction between 280 and 450° C.

The peak around 430° C. may be related to condensation of aromatic rings resulting in formation of char.

The carbon in the char could be further condensed to graphite like rings.

These results suggest that in some embodiments lignin does not melt but decomposes and then condenses.

The second endotherm situated between 130 and 250° C. could be considered as a softening point of lignin.

Kraft lignin contains 3 transition points realized as 3 exotherms while lignin according to various exemplary embodiments of the invention contains only one exotherm.

### Example 8

### SEM Analysis

FIG. 2 shows that HCl Lignin (panels g, h, i and j) is characterized by a woody structure with tunnels or tubules. This structure is observed also in the Residual Lignin of <200 mesh size fraction (panels a, b and c), in the Klason lignin (panels d, e and f), and the enzymatically treated lignin (panels k, l and m).

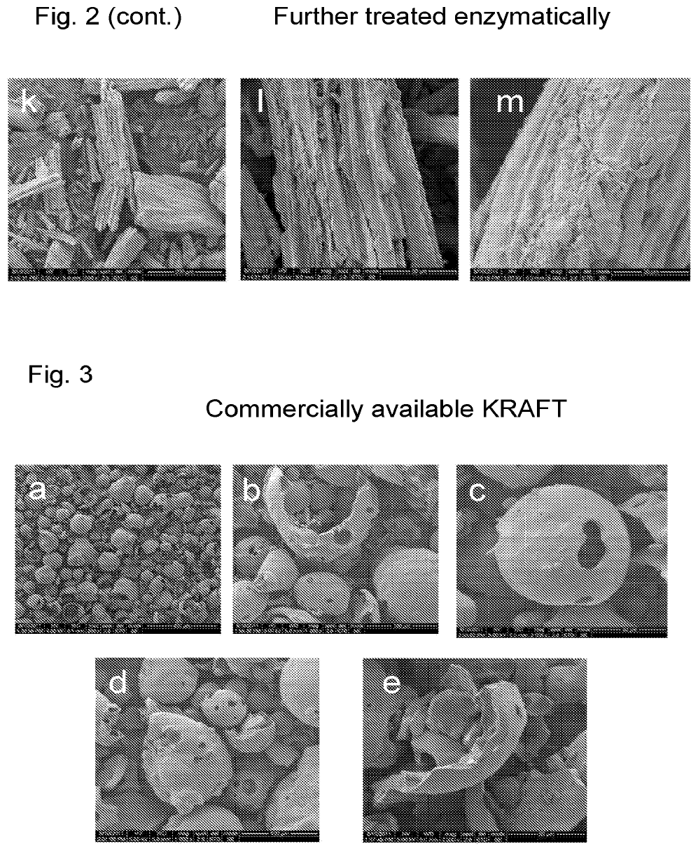

In sharp contrast, Kraft lignin (FIG. 3 panels a, b, c, d and e) exhibits a globular morphology.

This observed difference could be explained by proposed mechanism from polymeric science. Polymers are believed to tend to reduce their surface energy and assume structures possessing low surface energy.

During the isolation process of Kraft lignin the molecules may try to decrease their surface energy and arrange spontaneously in the observed globular structure. It is noted that sample preparation for SEM was identical for lignin according to various exemplary embodiments of the invention and Kraft lignin.

### Example 9

### Solubility

Solubility of HCl lignin in various organic solvents was assayed as described above. Results are summarized in Table 9.

TABLE 9
Solubility of lignin in various organic solvents

| Solvent | Percent solubility | Phenols in Ethanol |
|---|---|---|
| DMF | 14% | 1.45% |
| 2-(2-ethoxyethoxy) ethylacetate | 4% | 0.69% |
| DMSO | 17.7% | 0.04% |

Lignin according an exemplary embodiment of the invention has a low solubility, even in DMSO. A high shear mixer makes no apparent contribution to solubility. Sedimentation was observed to occur after mixing. In sharp contrast, Kraft lignin and organosolv lignin are completely soluble in DMSO.

Some exemplary embodiments of the invention, relate to lignin with a solubility of less than 20% in DMF and/or DMSO under the described conditions.

### Example 10

### Porosity Analysis Based Upon SEM Measurements

FIG. 5 is an enlarged version of the SEM of Residual Lignin in FIG. 2b. Representative measurements are superimposed on the figure.

The observed tubules or pores are characterized by a transverse cross-sectional dimension of about 5 to 20 μm with many having a transverse cross-sectional dimension of about 6 to 10 μm.

According to various exemplary embodiments of the invention, the aspect ratio of a transverse cross-sectional dimension to length of the observed tubules is less than 0.1, less than 0.05, less than 0.025, less than 0.02, or less than 0.01.

Similar structures are observed in HCl lignin, Klason Lignin and enzyme treated lignin, but not in Kraft lignin.

### Example 11

### Cl Content

Residual Lignin as described herein has a higher chloride (Cl) content than Kraft lignin. This is also true for HCl lignin, Klason Lignin and Enzymatically treated lignin produced from the Residual Lignin. The Cl in Kraft lignin is derived only from the wood. The Cl content of untreated pinewood is typically between about 0.001 and about 0.01% by weight. Assuming that all of this Cl ends up in Kraft lignin, there would be between about 0.003 and 0.03% Cl by weight, assuming 30% lignin. Since there is no evidence that all of the Cl remains in the lignin, actual values may be considerably lower for Kraft lignin.

Various exemplary embodiments of the invention relate to lignin comprising greater than 0.03%, 0.09%, 0.3%, 0.09%, 0.3%, 0.5% or 0.9%, Cl or to compositions containing such lignin.

### Example 12

### Solubility in NaOH

Samples of HCl lignin according to an exemplary embodiment of the invention and Kraft lignin were incubated in 5% NaOH for 3 hours at 75° C.

Kraft lignin was 81% soluble under these conditions while the HCl lignin was 9% soluble. Solubility was determined using by weight difference.

Various exemplary embodiments of the invention relate to lignin which is less than 50% soluble, less than 40% soluble, less than 30% soluble, less than 20% soluble, less than 10% soluble, or about 9% soluble in 5% NaOH under the described conditions.

### Example 13

### Olfactory Qualities

About 2 to 3 g of each of Kraft Lignin and HCl Lignin were evenly distributed on separate Petri dishes (I.D. 5 cm). Both sets of lignin were covered with water and heated to 90° C. Kraft Lignin and HCl Lignin each presented a distinctive aroma profile after two to three minutes.

HCl Lignin according to an exemplary embodiment of the invention had an ethereal, vanillic, slightly spicy, and clove-like aroma. In sharp contrast, the Kraft lignin had a moldy, smoky, and pungent aroma with burned notes.

### Example 14

### Proof of Principle for Spinning of Lignin

In order to demonstrate that HCl lignin compositions have the potential to serve as starting materials for industrial fiber spinning applications, the following experiment was conducted:

HCl Lignin (400 g) was heated in 10 liters of water with 300 g NaOH at 170° C. for 6 hours. The resultant lignin solution was dialyzed using a dialysis tube with 1 kDa cut-off. The dialyzed solution containing the retained lignin was then concentrated to 4% dissolved solids using a rotary evaporator.

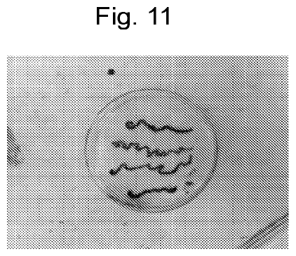

This concentrated solution was then loaded into a syringe and injected into a solution of ethanol and acetic acid. The acidified ethanol mixture served as an anti-solvent which caused the lignin to return to the solid phase as depicted in FIG. 11.

These results demonstrate that liquid lignin compositions according to exemplary embodiments of the invention can serve as input material for industrial spinning processes (e.g. wet spinning).

Some exemplary embodiments of the invention relate to conversion of lignin from a dissolved state to a solid state by contacting the dissolved lignin with an aliphatic alcohol (e.g. a pentanols, a butanol, a propanol, ethanol or methanol) and/or a weak acid (e.g. carbonic acid and/or acetic acid).

### Example 15

### Effect of Additional Hydrolysis on Elemental Composition of Lignin

In order to demonstrate the influence of HCl hydrolysis on lignin 220 (FIG. 1), elemental analyses were conducted using the following protocol:

Percentages of carbon, nitrogen, hydrogen and sulfur in the samples were determined by a FLASH EA 1112 CHNS Analyzer (CE Instruments). An EA 1110 (CE Instruments) analyzer was used for oxygen analysis. Samples were incinerated under 900° C. using He and O₂ atmosphere with flow rates of 140 ml/min and 250 ml/min respectively for CHNS determination and He atmosphere with flow rate of 140 ml/min for 0 determination.

Elemental analyses were conducted on two Residual Lignin samples (additional hydrolysis: No) and on two HCl Lignin samples derived from them (additional hydrolysis: Yes). Results are summarized in table 10. Values for commercially available Kraft lignin are provided for comparison. In this Example, values for 0 are by direct measurement and are believed to be more accurate than those presented in Example 3 (tables 5a and 5b). Calculation by difference in Example 3 and direct measurement as used in this Example accounts for the difference between elemental formula presented in Tables 5a and 10.

Results presented in table 10 indicate that acid hydrolysis using hydrochloric acid reduced the relative concentration of oxygen (O) and increased the relative amount of carbon (C) in the lignin material in the remaining lignin material. This improved profile is beneficial in the production of fuel products where reduced oxygen concentration is desired.

### Example 16

### Use of Lignin as a Filler

In order to investigate the feasibility of compounding HCl lignin according to an exemplary embodiment of the invention with synthetic polymeric materials, a series of plastics were prepared using polypropylene and varying amounts of lignin as a filler. Representative mechanical properties of the resulting plastics were tested as follows:
DMA storage modulus (ASTM D4065, Cantilever mode);
Flexural modulus test (ASTM D790), 3 point bending; and
Transition temperature (ASTM D-3418; characterized using DSC Q100 device of TA Instruments).

Compositions and their corresponding mechanical properties are presented in table 11. Values for 100% polypropylene (PP R-50) are provided for reference. Samples D, E and F include a commercially available flame retardant.

TABLE 11
Mechanical properties of plastics compounded with varying amounts of lignin.

| | | SAMPLE | | | | | | |
|---|---|---|---|---|---|---|---|---|
| Component | | PP | A | B | C | D | E | F |
| All values are % of total | | R-50 | | | | (control | | (control |
| weight | | control | | | | for E) | | for E) |
| PP R-50 | | 100 | 73.5 | 73.5 | 70 | 40 | 40 | 36 |
| Melapur MP | | — | 21 | — | 10 | — | — | — |
| PER | | — | 5.5 | — | — | — | — | — |
| Lignin | | — | — | 26.5 | 10 | — | 15 | — |
| Reofos TPP | | — | — | — | 10 | — | — | — |
| MDH* 120 DS-10 | | — | — | — | — | 60 | 45 | — |
| MDH* 100 DS-10 | | — | — | — | — | — | — | 60 |
| Polybond 3035 | | — | — | — | — | — | — | 4 |
| Mechanical property | | | | | | | | |
| DMA | Temperature, | | | | | | | |
| Storage | ° C. | | | | | | | |
| Modulus, | 0 | 2897 | 3242 | 3097 | 2247 | 5481 | 4908 | 5369 |
| MPa | 25 | 1771 | 2112 | 2136 | 1379 | 3632 | 3431 | 4052 |
| | 50 | 1169 | 1548 | 1545 | 951 | 2441 | 2421 | 3221 |
| | 70 | 769 | 1142 | 1092 | 654 | 1545 | 1664 | 2642 |
| | 90 | 546 | 841 | 820 | 461 | 1060 | 1207 | 2099 |
| | 100 | 459 | 720 | 711 | 384 | 877 | 1025 | 1859 |

| | | | | | | | |
|---|---|---|---|---|---|---|---|
| Flexural Modulus, MPa | 1628 | 2244 | 2017 | 1366 | 4065 | 3725 | 6215 |
| DSC, Tc, ° C. | 109.5 | | 116.5 | 114.2 | 113.4 | 115.9 | |

*Commercial MgOH based flame retardant (Dead Sea Bromine Compounds; Israel)

Results summarized in table 11 indicate that:

Composition B with 26.5% HCl lignin by weight demonstrated improved hardness and thermal stability, expressed as DMA storage modulus and flexural modulus, relative to PP R-50.

Fire retardant composition E in which 15% HCl lignin replaced a similar amount of MDH demonstrated enhanced thermal stability at elevated temperatures (DMA data) compared with control flame retardant composition D.

Each of compositions B, C and E demonstrated increased crystallization temperatures (DSC data). This increase in crystallization temperature is important in an industrial context because it contributes to a reduction in cooling time. Reduced cooling times in injection molding and/or extrusion processes contribute to an increase in overall operational; efficiency and/or output.

These results suggest that lignin according to exemplary embodiments of the invention can be compounded with a wide range of synthetic polymeric materials (e.g. polypropylene; ABS; PAN and nylon). Alternatively or additionally, these results suggest that such compounding contributes to an increase in DMA storage modulus and/or an increase in flexural modulus, and/or an increase in DSC transition temperature.

### Example 17

### Use of Lignin in Flame Retardant Compositions

In order to investigate the feasibility of using lignin HCl lignin in flame retardant materials a series of flame retardant plastics were prepared using polypropylene and varying amounts of lignin filler in conjunction with a conventional flame retardant.

A composition including 40% polypropylene (PP R-50), 45% Magnesium hydroxide (MDH 120 DS10) and 15% HCl lignin meets the criteria of UL 94 V-2 for flame retardation (Sample E in the previous example). This formulation exhibited satisfactory performance in compression molding.

Results presented in this example and the previous example indicate that lignin can be used as a filler in plastics, even flame retardant plastics.

### Example 18

### Use of Lignin in Acrylonitrile Butadiene Styrene (ABS) Based Compositions

In order to evaluate the feasibility of compounding lignin HCl lignin in acrylonitrile butadiene styrene (ABS) polymer based compositions a series often additional compositions was prepared under normal compounding conditions. Some of the compositions included commercially available phosphate based flame retardants (Reofos TPP and/or Reofos RDP; Polymate; People's Republic of China). In addition the compositions included a stabilizer (Irganox 1076; BASF Schweiz AG (formerly Ciba specialty Chemicals); Basel; Switzerland).

Compositions 6 and 10 without flame retardant served as negative controls in UL 94 assays of flame retardation. The compositions and their performance in UL 94 flame retardation assay and compression molding at elevated temperatures are summarized in Table 12.

TABLE 12
Exemplary acrylonitrile butadiene styrene (ABS) compositions and their performance

Component

| All values are % of | Composition | | | | | | | | | |
|---|---|---|---|---|---|---|---|---|---|---|
| total weight | 1 | 2 | 3 | 4 | 5 | 6 | 7 | 8 | 9 | 10 |
| ABS Polylac 757 | 84.5 | 79.5 | 74.5 | 69.5 | 69.5 | 74.5 | 69.5 | 69.5 | 59.5 | 95.5 |
| Irganox 1076 | 0.5 | 0.5 | 0.5 | 0.5 | 0.5 | 0.5 | 0.5 | 0.5 | 0.5 | 0.5 |
| Reofos TPP | 15 | 15 | 15 | 10 | 15 | — | 10 | 5 | — | — |
| Reofos RDP | — | — | — | — | — | — | 5 | 5 | 10 | — |
| Lignin | — | 5 | 10 | 20 | 15 | 25 | 15 | 20 | 30 | — |
| Properties | | | | | | | | | | |
| UL 94 V-2 | NO | YES | YES | NO | YES | NO | YES | NO | NO | NO |
| Compliant? | | | | | | | | | | |
| Compression | bubble | bubble | bubble | bubble | bubble | bubble | bubble | bubble | bubble | bubble |
| molding: 180° C. | free | free | free | free | free | free | free | free | free | free |
| Compression | bubble | bubble | bubble | bubble | bubble | bubble | bubble | bubble | bubble | bubble |
| molding: 200° C. | free | free | free | free | free | free | free | free | free | free |

Compositions 2, 3, 5 and 7 were determined to comply with UL 94 V-2 flame retardation requirements. Composition 3 performed slightly better than compositions 2, 5 and 7.

All of the tested compositions exhibited satisfactory performance in compression molding at 180 and 200° C.

These results confirm that lignin can be incorporated into an ABS based composition as a filler at 5 to 30% without adversely affecting molding properties at relevant temperatures. In contrast to Example 16, the lignin was substituted for the synthetic polymer in this experiment (compare compositions 2 and 3 to 1).

The results also indicate that lignin can impart flame retardant qualities to a composition which would not be flame retardant without lignin (compare compositions 2 and 3 to composition 1).

These results are consistent with those of the previous two examples in suggesting that lignin can be used as a filler with a wide range of synthetic polymers, even if flame retardation requirements are a manufacturing constraint.

1.-116. (canceled)

117. A lignin composition characterized, on a dry matter basis, by at least 0.05% carboxylic functions, a sulfur content of less than 0.07%, a total carbohydrate content of less than 0.05%, and at least one characteristic selected from the group consisting of:
(a) a ratio of C/H/O of 9/X/Y, wherein X is at least 9 and Y is less than 5;
(b) an O/C ratio of less than 0.34;
(c) an O/C ratio less than previously reported for lignin from a same specific lignocellulosic source;
(d) an H/C ratio of less than 2;
(e) an ash content of less than 0.5%;
a phosphorus content of less than 100 PPM;
(g) a soluble carbohydrate content of less than 5%;
(h) a marker molecule content of at least 10 PPM;
(i) total non lignin components ≤5%;
(j) less than 3% non-lignin material; and
(k) a volatiles content of less than 5% at 200° C.;
wherein said composition is provided as a solution in a main solvent.

118. The composition according to claim 117, characterized, on a dry matter basis, by at least two said characteristics.

119. The composition according to claim 117, characterized, on a dry matter basis, by at least three said characteristics.

120. The composition according to claim 117, characterized, on a dry matter basis, by at least four said characteristics.

121. The composition according to claim 117, characterized, on a dry matter basis, by at least five said characteristics.

122. The composition according to claim 117, prepared from a substrate comprising hardwood, a substrate comprising softwood, or a substrate comprising hardwood and softwood.

123. A product comprising the lignin composition according to claim 117 and one or more other ingredients, wherein the product is a product selected from the group consisting of: carbon fibers, protective coatings, lignosulfonates, pharmaceuticals, dispersants, emulsifiers, complexants, flocculants, agglomerants, pelletizing additives, resins, adhesives, binders, absorbents, toxin binders, films, rubbers, elastomers, sequestrants, solid fuels, paints, dyes, plastics, wet spun fibers, melt spun fibers and flame retardants.

124. A spinning method comprising:
(a) providing the lignin composition according to claim 117 and contacting said composition with an anti-solvent;
(b) spinning said lignin composition resulting from (a) to produce fibers; and
(c) de-solventizing said fibers.

125. The composition according to claim 117, comprising:
at least 20% lignin by weight; and
a sulfur concentration of less than 0.07% by weight;
wherein at least 10% of the lignin has a molecular weight of less than 10 kDa.

126. The composition according to claim 125, wherein at least 10% of the lignin has a molecular weight in the range between 0.2 kDa and 5 kDa.

127. The composition according to claim 125, comprising an organic solvent, wherein the organic solvent is selected from the group consisting of an alcohol, a ketone, an aldehyde, an alkane, an organic acid and a furan of 6 carbons or less.

128. A method comprising:
(a) providing a composition according to claim 117, and
(b) converting at least a portion of lignin in said composition to a conversion product.

129. The method according to claim 128, comprising producing hydrogen from lignin.

130. The method according to claim 128, wherein said conversion product comprises at least one item selected from the group consisting of a fuel or a fuel ingredient, bio-oil, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, phenols, toluenes, and xylenes.

131. The method according to claim 128, wherein said converting comprises treating with hydrogen, aqueous phase reforming (APR), or at least one reaction type selected from the group consisting of catalytic hydrotreating, catalytic condensation, zeolite catalyzed acid condensation, base catalyzed condensation, hydrogenation, dehydration, alkene oligomerization and alkylation (alkene saturation).

132. The composition according to claim 117, characterized by a volatiles content of less than 5% at 200° C.

133. The composition according to claim 117, characterized by an ash content of less than 0.5%.

134. The composition according to claim 133, wherein the ash comprises aluminum, calcium, iron, potassium, magnesium, sodium, sulfur, silicon and zinc.

135. The composition according to claim 117, characterized by:
a ratio of C/H/O of 9/X/Y, wherein X is at least 9 and Y is less than 5;
an O/C ratio of less than 0.34;
an ash content of less than 0.5%;
a sulfur content of less than 0.07%; and
a soluble carbohydrate content of less than 5%.

136. The composition according to claim 117, further comprising at least 10 ppm of hexanol or 2-ethyl-1-hexanol.
